(19) United States
(12) Patent Application Publication
(10) Pub. No.: US 2025/0267727 A1
(43) Pub. Date: Aug. 21, 2025

(54) CHANNEL ACCESS TECHNIQUES FOR MULTI-BAND OPERATION

(71) Applicant: QUALCOMM Incorporated, San Diego, CA (US)

(72) Inventors: Abhishek Pramod PATIL, San Diego, CA (US); George CHERIAN, San Diego, CA (US); Gaurang NAIK, San Diego, CA (US); Giovanni CHISCI, San Diego, CA (US); Alfred ASTERJADHI, San Diego, CA (US)

(21) Appl. No.: 18/766,309

(22) Filed: Jul. 8, 2024

Related U.S. Application Data
(60) Provisional application No. 63/555,811, filed on Feb. 20, 2024.

(51) Int. Cl. H04W 74/0833; H04W 16/14; H04W 28/20; H04W 48/10

(52) U.S. Cl. CPC H04W 74/0841; H04W 16/14; H04W 28/20; H04W 48/10

(57) ABSTRACT

This disclosure provides methods, components, devices and systems for channel access techniques for multi-band operation. Some aspects more specifically relate to transmission of control signaling that on a first radio frequency (RF) band that facilitates wireless communication on a second RF band. In some examples, a first wireless communication device may transmit, via a first RF band, control signaling that includes one or more indications of a medium time interval for a second RF band for communication between the first wireless communication device and two or more second wireless communication devices. The medium time interval may include one or more dedicated service periods (D-SPs) that may be shared by two or more of the second wireless communication devices, one or more durations available for contention-based access for the second wireless communication devices via the first RF band, or one or more on-demand service periods (O-SPs).

### CROSS REFERENCE

The present Application for Patent claims the benefit of U.S. Provisional Patent Application No. 63/555,811 by PATIL et al., entitled “CHANNEL ACCESS TECHNIQUES FOR MULTI-BAND OPERATION,” filed Feb. 20, 2024, assigned to the assignee hereof, and expressly incorporated by reference herein.

### TECHNICAL FIELD

This disclosure relates generally to wireless communication and, more specifically, to techniques for channel access for multi-band operation.

### DESCRIPTION OF THE RELATED TECHNOLOGY

Wireless communication networks are widely deployed to provide various types of communication content such as voice, video, packet data, messaging, broadcast, and so on. Some wireless communication networks may be capable of supporting communication with multiple users by sharing the available system resources (such as time, frequency, or power). Further, a wireless communication network may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM), among other examples. Wireless communication devices may communicate in accordance with any one or more of such wireless communication technologies, and may include wireless stations (STAs), wireless access points (APs), user equipment (UEs), network entities, or other wireless nodes.

In some wireless local area networks (WLANs), wireless communication devices may support communication via a 60 gigahertz (GHz) radio frequency (RF) band, which may provide a large available spectrum. Some WLANs may support multi-link operation (MLO) (which may also be referred to as multi-band operation) in which the devices may communicate over multiple frequency ranges. For example, a wireless communication device in a WLAN may communicate over a first RF band (such as one of a 2.4 GHz band, a 3.5 GHz band, a 5 GHz band, or a 6 GHz band) and a second RF band (such as a 2.4 GHz band, a 3.5 GHz band, a 5 GHz band, a 6 GHz band, a 45 GHz band, or a 60 GHz band). The 2.4 GHz band, the 3.5 GHz band, the 5 GHz band, and the 6 GHz band may be referred to as sub-7 GHz (or simply “sub7”) bands or links. Communication over relatively high frequency bands, such as the 60 GHz band may result in high propagation loss, and thus communication between devices over a 60 GHz RF band may demand beamforming on both ends (such as the transmitter side and the receiver side). Scheduling communication over RF bands that demand beamforming on both ends may involve high control signaling overhead as such signaling may involve both the transmitter side and the receiver side tuning beams to transmit and receive the control signaling and as such signaling may involve transmission of separate signaling to each client device. However, communication over one or more sub7 bands may be performed with or without beamforming.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication performed by a first wireless communication device. The method may include transmitting, via a first radio frequency (RF) band, one or more indications of a medium time interval for a second RF band that is different than the first RF band, the one or more indications including one or more of: an indication of one or more shared dedicated service periods (D-SPs) for communication on the second RF band with a first set of two or more second wireless communication devices via time division multiplexing (TDM), frequency division multiplexing (FDM), or spatial division multiplexing (SDM); an indication of one or more on-demand service periods (O-SPs) available for allocation by the first wireless communication device to a second set of one or more second wireless communication devices during the medium time interval in association with pending buffered data to transmit that arrived during the medium time interval and before a start of the one or more O-SPs; or an indication of one or more durations of the medium time interval available for a third set of one or more second wireless communication devices for contention-based access via the first RF band, and communicating, via the second RF band and in accordance with the medium time interval, with a second wireless communication device of the first set of two or more second wireless communication devices, the second set of one or more second wireless communication devices, or the third set of one or more second wireless communication devices.

Another innovative aspect of the subject matter described in this disclosure can be implemented in a first wireless communication device for wireless communication. The first wireless communication device may include a processing system that includes processor circuitry and memory circuitry that stores code. The processing system may be configured to cause the first wireless communication device to transmit, via a first RF band, one or more indications of a medium time interval for a second RF band that is different than the first RF band, the one or more indications including one or more of: an indication of one or more shared D-SPs for communication on the second RF band with a first set of two or more second wireless communication devices via TDM, FDM, or SDM; an indication of one or more O-SPs available for allocation by the first wireless communication device to a second set of one or more second wireless communication devices during the medium time interval in association with pending buffered data to transmit that arrived during the medium time interval and before a start of the one or more O-SPs; or an indication of one or more durations of the medium time interval available for a third set of one or more second wireless communication devices for contention-based access via the first RF band, and communicate, via the second RF band and in accordance with the medium time interval, with a second wireless communication device of the first set of two or more second wireless communication devices, the second set of one or more second wireless communication devices, or the third set of one or more second wireless communication devices.

Another innovative aspect of the subject matter described in this disclosure can be implemented in a first wireless communication device for wireless communication performed. The first wireless communication device may include means for transmitting, via a first RF band, one or more indications of a medium time interval for a second RF band that is different than the first RF band, the one or more indications including one or more of: an indication of one or more shared D-SPs for communication on the second RF band with a first set of two or more second wireless communication devices via TDM, FDM, or SDM; an indication of one or more O-SPs available for allocation by the first wireless communication device to a second set of one or more second wireless communication devices during the medium time interval in association with pending buffered data to transmit that arrived during the medium time interval and before a start of the one or more O-SPs; or an indication of one or more durations of the medium time interval available for a third set of one or more second wireless communication devices for contention-based access via the first RF band, and means for communicating, via the second RF band and in accordance with the medium time interval, with a second wireless communication device of the first set of two or more second wireless communication devices, the second set of one or more second wireless communication devices, or the third set of one or more second wireless communication devices.

Another innovative aspect of the subject matter described in this disclosure can be implemented in a non-transitory computer-readable medium storing code for wireless communication. The code may include instructions executable by one or more processors to transmit, via a first RF band, one or more indications of a medium time interval for a second RF band that is different than the first RF band, the one or more indications including one or more of: an indication of one or more shared D-SPs for communication on the second RF band with a first set of two or more second wireless communication devices via TDM, FDM, or SDM; an indication of one or more O-SPs available for allocation by the first wireless communication device to a second set of one or more second wireless communication devices during the medium time interval in association with pending buffered data to transmit that arrived during the medium time interval and before a start of the one or more O-SPs; or an indication of one or more durations of the medium time interval available for a third set of one or more second wireless communication devices for contention-based access via the first RF band, and communicate, via the second RF band and in accordance with the medium time interval, with a second wireless communication device of the first set of two or more second wireless communication devices, the second set of one or more second wireless communication devices, or the third set of one or more second wireless communication devices.

Some examples of the method, first wireless communication devices, and non-transitory computer-readable medium described herein may further include operations, features, means, or instructions for transmitting, over a temporally-first portion of the medium time interval and via the second RF band, a reference frame for the medium time interval, where the one or more indications of the medium time interval further include an indication of a timing of the reference frame for the medium time interval.

Some examples of the method, first wireless communication devices, and non-transitory computer-readable medium described herein may further include operations, features, means, or instructions for transmitting, via the first RF band, a frame advertising an availability of a set of D-SPs within the medium time interval, the set of D-SPs including the one or more shared D-SPs and receiving, via the first RF band from the second wireless communication device and responsive to the frame, a request to use the one or more shared D-SPs, where transmission of the one or more indications of the medium time interval may be in association with reception of the request, and where the first set of two or more second wireless communication devices includes the second wireless communication device.

Some examples of the method, first wireless communication devices, and non-transitory computer-readable medium described herein may further include operations, features, means, or instructions for receiving, via the first RF band from the second wireless communication device, a request for establishing the one or more shared D-SPs on the second RF band, where transmission of the one or more indications of the medium time interval may be in association with reception of the request.

In some examples of the method, first wireless communication devices, and non-transitory computer-readable medium described herein, communicating with the second wireless communication device may include operations, features, means, or instructions for transmitting, to the second wireless communication device and via the second RF band, a frame including an indication that the first wireless communication device intends to service the second wireless communication device over a first shared D-SP of the one or more shared D-SPs and communicating data with the second wireless communication device over the first shared D-SP via the second RF band in association with transmission of the frame.

In some examples of the method, first wireless communication devices, and non-transitory computer-readable medium described herein, transmitting the one or more indications of the medium time interval may include operations, features, means, or instructions for transmitting the indication of the one or more O-SPs, where communicating with the second wireless communication device includes communicating with the second wireless communication device over a first O-SP of the one or more O-SPs.

Some examples of the method, first wireless communication devices, and non-transitory computer-readable medium described herein may further include operations, features, means, or instructions for receiving, from the second wireless communication device, a request to use the first O-SP, where communication with the second wireless communication device over the first O-SP may be in association with reception of the request.

Some examples of the method, first wireless communication devices, and non-transitory computer-readable medium described herein may further include operations, features, means, or instructions for communicating, with the second wireless communication device and via the first RF band, a request to use a first duration of the one or more durations on the second RF band for communication with the second wireless communication device and communicating, with the second wireless communication device via the first RF band and in association with communication of the request, a response that indicates an intention to use the second RF band for the first duration for communication with the second wireless communication device.

Another innovative aspect of the subject matter described in this disclosure can be implemented in a method for wireless communications by a first wireless communication device. The method may include receiving, via a first RF band and from a second wireless communication device, one or more indications of a medium time interval for a second RF band that is different than the second RF band, the one or more indications including one or more of: an indication of one or more shared D-SPs for communication on the second RF band with a first set of two or more first wireless communication devices via TDM, FDM or SDM, the first set of two or more first wireless communication devices including the first wireless communication device; an indication of one or more O-SPs available for allocation by the second wireless communication device to a second set of one or more first wireless communication devices during the medium time interval in association with pending buffered data to transmit that arrived during the medium time interval and before a start of the one or more O-SPs, the second set of one or more first wireless communication devices including the first wireless communication device; or an indication of one or more durations of the medium time interval available for a third set of one or more first wireless communication devices for contention-based access via the first RF band, the third set of one or more first wireless communication devices including the first wireless communication device, and communicating, via the second RF band and in accordance with the medium time interval, with the second wireless communication device.

Another innovative aspect of the subject matter described in this disclosure can be implemented in a first wireless communication device for wireless communications. The first wireless communication device may include a processing system that includes processor circuitry and memory circuitry that stores code. The processing system may be configured to cause the first wireless communication device to receive, via a first RF band and from a second wireless communication device, one or more indications of a medium time interval for a second RF band that is different than the second RF band, the one or more indications including one or more of: an indication of one or more shared D-SPs for communication on the second RF band with a first set of two or more first wireless communication devices via TDM, FDM, or SDM, the first set of two or more first wireless communication devices including the first wireless communication device; an indication of one or more O-SPs available for allocation by the second wireless communication device to a second set of one or more first wireless communication devices during the medium time interval in association with pending buffered data to transmit that arrived during the medium time interval and before a start of the one or more O-SPs, the second set of one or more first wireless communication devices including the first wireless communication device; or an indication of one or more durations of the medium time interval available for a third set of one or more first wireless communication devices for contention-based access via the first RF band, the third set of one or more first wireless communication devices including the first wireless communication device, and communicate, via the second RF band and in accordance with the medium time interval, with the second wireless communication device.

Another innovative aspect of the subject matter described in this disclosure can be implemented in a first wireless communication device for wireless communications. The first wireless communication device may include means for receiving, via a first RF band and from a second wireless communication device, one or more indications of a medium time interval for a second RF band that is different than the second RF band, the one or more indications including one or more of: an indication of one or more shared D-SPs for communication on the second RF band with a first set of two or more first wireless communication devices via TDM, FDM, or SDM, the first set of two or more first wireless communication devices including the first wireless communication device; an indication of one or more O-SPs available for allocation by the second wireless communication device to a second set of one or more first wireless communication devices during the medium time interval in association with pending buffered data to transmit that arrived during the medium time interval and before a start of the one or more O-SPs, the second set of one or more first wireless communication devices including the first wireless communication device; or an indication of one or more durations of the medium time interval available for a third set of one or more first wireless communication devices for contention-based access via the first RF band, the third set of one or more first wireless communication devices including the first wireless communication device, and means for communicating, via the second RF band and in accordance with the medium time interval, with the second wireless communication device.

Another innovative aspect of the subject matter described in this disclosure can be implemented in a non-transitory computer-readable medium storing code for wireless communication. The code may include instructions executable by one or more processors to receive, via a first RF band and from a second wireless communication device, one or more indications of a medium time interval for a second RF band that is different than the second RF band, the one or more indications including one or more of: an indication of one or more shared D-SPs for communication on the second RF band with a first set of two or more first wireless communication devices via TDM, FDM, or SDM, the first set of two or more first wireless communication devices including the first wireless communication device; an indication of one or more O-SPs available for allocation by the second wireless communication device to a second set of one or more first wireless communication devices during the medium time interval in association with pending buffered data to transmit that arrived during the medium time interval and before a start of the one or more O-SPs, the second set of one or more first wireless communication devices including the first wireless communication device; or an indication of one or more durations of the medium time interval available for a third set of one or more first wireless communication devices for contention-based access via the first RF band, the third set of one or more first wireless communication devices including the first wireless communication device, and communicate, via the second RF band and in accordance with the medium time interval, with the second wireless communication device.

Some examples of the method, first wireless communication devices, and non-transitory computer-readable medium described herein may further include operations, features, means, or instructions for receiving, from the second wireless communication device over a temporally first portion of the medium time interval and via the second RF band, a reference frame for the medium time interval, where the one or more indications of the medium time interval further include an indication of a timing of the reference frame for the medium time interval.

Some examples of the method, first wireless communication devices, and non-transitory computer-readable medium described herein may further include operations, features, means, or instructions for receiving, from the second wireless communication device and via the first RF band, a frame advertising an availability of a set of D-SPs within the medium time interval, the set of D-SPs including the one or more shared D-SPs and transmitting, to the second wireless communication device via the first RF band and responsive to the frame, a request to use the one or more shared D-SPs, where reception of the one or more indications of the medium time interval may be in association with transmission of the request.

Some examples of the method, first wireless communication devices, and non-transitory computer-readable medium described herein may further include operations, features, means, or instructions for transmitting, to the second wireless communication device and via the first RF band, a request for establishing the one or more shared D-SPs on the second RF band, where reception of the one or more indications of the medium time interval may be in association with transmission of the request.

In some examples of the method, first wireless communication devices, and non-transitory computer-readable medium described herein, communicating with the second wireless communication device may include operations, features, means, or instructions for receiving, from the second wireless communication device and via the second RF band, a frame including an indication that the second wireless communication device intends to service the first wireless communication device over a first shared D-SP of the one or more shared D-SPs and communicating data with the second wireless communication device over the first shared D-SP via the second RF band in association with reception of the frame.

In some examples of the method, first wireless communication devices, and non-transitory computer-readable medium described herein, receiving the one or more indications of the medium time interval may include operations, features, means, or instructions for receiving the indication of the one or more O-SPs, where communicating with the second wireless communication device includes communicating with the second wireless communication device over a first O-SP of the one or more O-SPs.

Some examples of the method, first wireless communication devices, and non-transitory computer-readable medium described herein may further include operations, features, means, or instructions for transmitting, to the second wireless communication device, a request to use the first O-SP, where communication with the second wireless communication device over the first O-SP may be in association with transmission of the request.

Some examples of the method, first wireless communication devices, and non-transitory computer-readable medium described herein may further include operations, features, means, or instructions for communicating, with the second wireless communication device and via the first RF band, a request to use a first duration of the one or more durations on the second RF band for communication with the second wireless communication device and communicating, with the second wireless communication device via the first RF band and in association with communication of the request, a response that indicates an intention to use the second RF band for the first duration for communication with the second wireless communication device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communication between a wireless access point (AP) and one or more wireless stations (STAs).

FIG. 3 shows an example of a medium time interval diagram that supports channel access for multi-band operation.

FIG. 4 shows an example of a medium time interval diagram that includes shared dedicated services periods (D-SPs) associated with two or more wireless communication devices that support channel access for multi-band operation.

FIG. 5 shows an example of a communication timeline for a D-SP that supports channel access for multi-band operation.

FIG. 6 shows an example of a communication timeline for an on-demand service period (O-SP) that supports channel access for multi-band operation.

FIG. 7 shows an example of a contention-based access process that supports channel access for multi-band operation.

FIG. 8 shows an example of a process flow that supports channel access for multi-band operation.

FIG. 9 shows a block diagram of an example wireless communication device that supports channel access for multi-band operation.

FIG. 10 shows a block diagram of an example wireless communication device that supports channel access for multi-band operation.

FIGS. 11 and 12 show flowcharts illustrating example processes performable by or at a first wireless communication device that supports channel access for multi-band operation.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Various aspects relate generally to transmission of control signaling on a first RF band that indicates a medium time interval for a second RF band to facilitate wireless communication on the second RF band. In some examples, an access point (AP) (such as an AP multi-link device (MLD) (AP MLD)) broadcasts or otherwise transmits frames via a first RF band, such as a sub-7 GHz band, that include one or more indications of a medium time interval associated with a second RF band, such as a 45 GHz or 60 GHz band. In some examples, the medium time interval may include one or more shared dedicated service periods (D-SPs) for communication between the AP MLD and wireless stations (STAs) (such as STA MLDs also referred to as non-AP MLDs). In some aspects, the medium time interval further includes one or more on-demand service periods (O-SPs) available for allocation by the AP MLD to one or more STA MLDs for transmission of pending buffered data that arrived during the medium time interval and before a start of the one or more O-SPs. In some examples, the medium time interval may include one or more durations during which the second RF band is available for contention-based access by the associated STA MLDs via transmission of signaling for the contention-based access on the first RF band. The one or more durations may be between other service periods (SPs) scheduled within the medium time interval (such as individual D-SPs, shared D-SPs, or O-SPs).

Particular aspects of the subject matter described in this disclosure can be implemented to realize one or more of the following potential advantages. In some examples, by indicating a medium time interval for a second RF band via a first RF band, the described techniques can be used to facilitate communication over one or more additional RF bands with reduced control signaling overhead. For example, control signaling overhead may be reduced by transmitting control signaling on a first RF band that does not demand beamforming on both ends to schedule a medium time interval for an RF band that does demand beamforming on both ends. As the first RF band may not demand beamforming on both ends, the control signaling that indicates the medium time interval may be broadcast, multicast, or groupcast to multiple STAs as compared to transmission of separate control signaling to each of the multiple STAs. In some wireless communication systems, communication over some RF bands such as the 3.5 GHz RF band may demand conformance with regulatory rules that demand a second wireless communication device may not access or occupy the RF band while an incumbent wireless communication device is accessing the medium or is scheduled to access the medium, and in such wireless communication systems, the second wireless communication system may use one RF band to access (for example, schedule service periods or contend for access on) the RF band that demands conformance with the regulatory rules. By including shared D-SPs, multiple wireless communication devices (such as STAs) may be serviced by a first wireless communication device during a same SP. For example, as communication on the second RF band may be spatially multiplexed via beamforming, higher throughput may be achieved via servicing multiple wireless communication devices during a same D-SP. In some examples, durations of the second RF band being available for contention-based access via the first RF band may enable otherwise unused communication resources to be better utilized. For example, time resources in the medium time interval between scheduled SPs that would otherwise be unused may be available for contention-based access. RF bands that are highly directional due to high propagation loss (such as the 60 GHz RF band) may be unsuitable for contention-based access due to the control signaling involved with contention-based access so use of a first RF band to perform contention-based access for the second RF band may enable utilization of otherwise unused resources of the second RF band. In some examples, by including O-SPs during the medium time interval, additional resources may be available to wireless communication devices to transmit buffered data that was not serviced during an earlier SP or that arrives during the medium time interval.

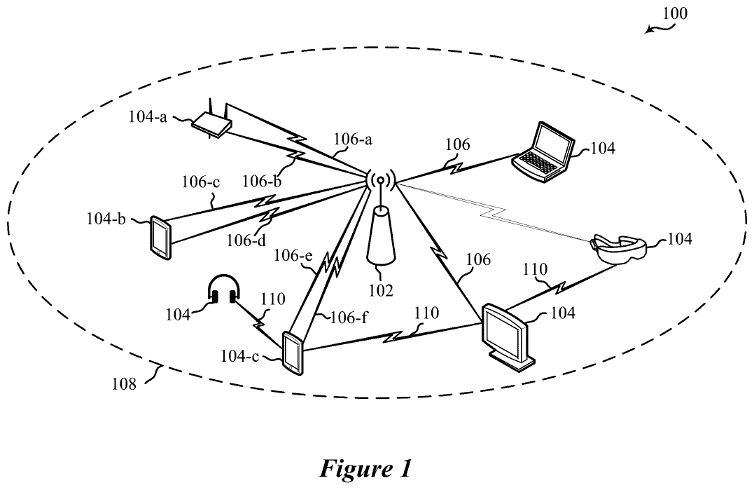

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless AP 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP MLD), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communication (hereinafter also referred to as “Wi-Fi communication” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHZ, 6 GHz, 45 GHz, and 60 GHz bands. Some examples of the APs 102 and STAs 104 described herein also may communicate in other frequency bands that may support licensed or unlicensed communication. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHz), FR4a or FR4-1 (52.6 GHz-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). In other different systems, any transmission by an AP 102 or a STA 104 within a BSS must involve transmission on the primary 20 MHz channel. As such, in other different systems, the transmitting device must contend on and win a TXOP on the primary channel to transmit anything at all. However, some APs 102 and STAs 104 supporting ultra-high reliability (UHR) communication or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

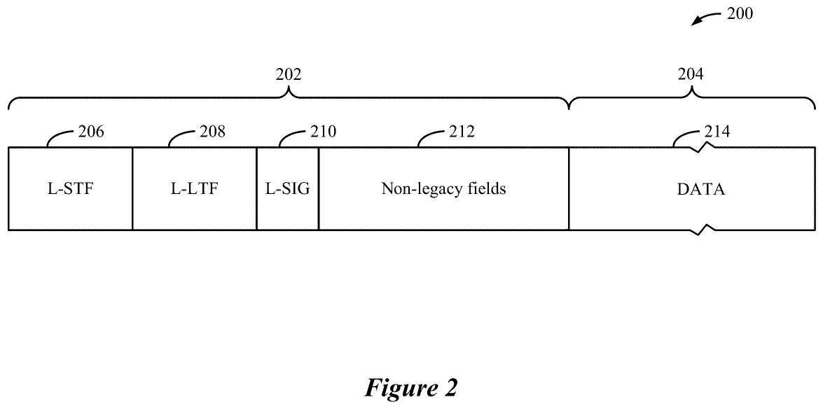

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Retransmission protocols, such as hybrid automatic repeat request (HARQ), also may offer performance gains. A HARQ protocol may support various HARQ signaling between transmitting and receiving wireless communication devices (for example, the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (for example, a negative acknowledgment (NACK)) that indicates at least part of the first HARQ transmission was not properly decoded. Such a HARQ feedback message may be different than the traditional Block ACK feedback message type associated with other different ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communication that employ ARQ with those that employ HARQ.

APs and STAs (for example, the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communication to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communication; that is, concurrent transmissions from one device to each of multiple devices (for example, multiple simultaneous downlink communication from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHZ, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as an MLD. In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communication links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communication between MLDs in the same direction (such as all uplink or all downlink), while in some other examples or durations of time, two or more of the communication links may be used for communication in different directions (for example, one or more communication links may support uplink communication and one or more communication links may support downlink communication). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users for each multiplexed transmission served by the multi-link AP MLD.

For example, the AP 102 may be an AP-MLD, the STA 104-a may be a non-AP MLD, the STA 104-b may be a non-AP MLD, and the STA 104-c may be a non-AP MLD. The AP 102 may communicate with the STA 104-a via a first communication link 106-a and a second communication link 106-b. The first communication link 106-a may be over a first RF band and the second communication link 106-b may be over a second RF band. Similarly, the AP 102 may communicate with the STA 104-b via a third communication link 106-c and a fourth communication link 106-d. The third communication link 106-c may be over the first RF band and the fourth communication link 106-d may be over the second RF band. In some examples, the AP 102 may communicate with the STA 104-c via a fifth communication link 106-e and a sixth communication link 106-f. The fifth communication link 106-e may be over the first RF band and the sixth communication link 106-f may be over a second RF band.

The AP 102 may facilitate communication over the second RF band (for example, over the second communication link 106-b, the fourth communication link 106-d, and/or the sixth communication link 106-f) via the first RF band (for example, the first communication link 106-a, the third communication link 106-c, and/or the fifth communication link 106-e). In some examples, the first RF band may be a sub7 RF band and the second RF band may be a 45 GHz RF band or a 60 GHz RF band. The first RF band may be used to exchange management-level information between the AP 102 and the STAs 104, for example, for discovery, association, authentication, and/or block acknowledgment (BA) setup. In some examples, the first RF band may be used to set up or schedule time periods (for example, SPs) for communication on the second RF band. For example, the target wake time (TWT) setup for the second RF band may be performed via a frame exchange on the first RF band. In some examples, some management level information may be transmitted in the second RF band (for example, beacons such as AP sector reference (ASR) frames may be broadcast during an ASR transmission period (ATP) on the second RF band). The first RF band may be used to coordinate transmissions amongst the participants on the second RF band (for example, the AP 102, the STA 104-a, the STA 104-b, and/or the STA 104-c). In some examples, the first RF band may be used to identify peer devices and/or initiate frame exchange on the second RF band via initial frame exchange on the first RF band.

In some examples, the medium time for the second RF band may be divided into a series of repeating segments (for example, medium time intervals for the second RF band). Each medium time interval may include one or more of: an ATP; one or more D-SPs; one or more O-SPs; or one or more durations available for contention-based access via the first RF band. A D-SP may refer to an SP scheduled prior to a medium time interval via one or more management frames (such as TWT setup frames) that are indicated as intended for communication between an AP 102 and one or more specific STAs 104. A shared D-SP may refer to a D-SP which the management frames designate for two or more STAs 104 for service during the D-SP. For example, a shared D-SP may be shared between two or more of the STA 104-a, the STA 104-b, and/or the STA 104-c. An individual D-SP may refer to a D-SP which the management frames designate for a single STA 104 for service during the D-SP. For example, an individual D-SP may be used for communication between an AP 102 and one of the STA 104-a, the STA 104-b, or the STA 104-c. STAs 104 may not contend for medium access for a D-SP. For example, the D-SPs may be used for downlink communication from the AP 102 to the STAs 104, trigger-based uplink communication from the STAs 104 to the AP 102, or non-trigger-based uplink communication from the STAs 104 to the AP 102 (such as for single user uplink communication). Within the medium time interval, an AP 102 may indicate (for example, via a polling frame) for a shared D-SP whether the AP 102 intends to service each STA 104 associated with the shared D-SP prior to the medium time interval (for example, in the one or more management frames). An AP 102 may not indicate (for example, may not transmit polling frames) within the medium time interval whether the AP intends to service an STA associated with an individual D-SP.

An O-SP may refer to an SP scheduled via one or more management frames that is indicated as available for allocation by an AP 102 to one or more STAs 104 during the medium time interval. An O-SP may be allocated by the AP 102 to one or more STAs 104 based on buffered data being available to transmit during the medium time interval. For example, the buffered data may be remaining at an end of a D-SP, another O-SP, or a contention-based access duration. For example, the buffered data may arrive at the buffer of the STA 104 (for example, from higher layers of the STA 104) or at the buffer of the AP 102 (for example, from higher layers of the AP 102) during the medium time interval. For example, an AP 102 may transmit an indication at an end of a D-SP or an O-SP indicating an allocation of a subsequent O-SP to communicate remaining buffered data that was not transmitted during the D-SP or O-SP. In some examples, a STA 104 may request to use an O-SP, and the AP 102 may indicate in response to the request, an allocation of a subsequent O-SP. As another example, the buffered data may become available for transmission during the medium time interval (for example, after an end of a D-SP, an O-SP, or a contention-based access duration). STAs 104 may not contend for medium access for an O-SP. For example, the O-SPs may be used for downlink communication from the AP 102 to the STAs 104, trigger-based uplink communication from the STAs 104 to the AP 102, or non-trigger-based uplink communication from the STAs 104 to the AP 102. In some examples, the first RF band may be a sub7 band, and the contention-based access for a duration on the second RF band may be performed (for example, at least partially) via exchange of signaling for the contention-based access over the first RF band. The durations within the medium time interval may be between scheduled D-SPs and O-SPs during the medium time interval, thereby allowing the otherwise unused durations to be available for contention-based communication. In some examples, a duration of a medium time interval of the second RF band available for contention-based access over the first RF band may overlap (for example, at least partially) in time with a D-SP or an O-SP. In some examples, the involved MLDs (for example, the AP 102, the STA 104-a, the STA 104-b, and/or the STA 104-c) may support a subset of capabilities or modes on communication over the second RF band. The MLDs may exchange capability information regarding supported modes of communication for second RF band, for example, at the time of association or in a post association management frame exchange.

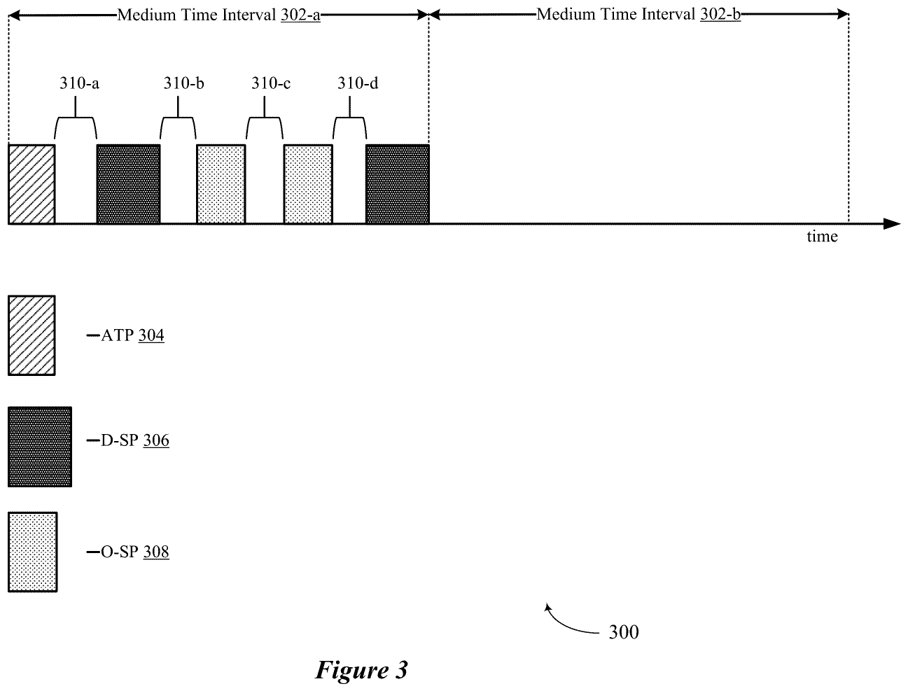

FIG. 3 shows an example of a medium time interval diagram 300 that supports channel access techniques for multi-band operation. In some examples, the medium time interval diagram 300 may implement or may be implemented by aspects of the wireless communication network 100. For example, wireless communication devices such as APs 102 and/or STAs 104 in a WLAN may be capable of MLO involving communication in accordance with the medium time intervals 302.

In some examples, a first wireless communication device (for example, an AP 102 that is an AP MLD as described with reference to FIG. 1) may use a first RF band to set up one or more medium time intervals 302 for a second RF band. For example, management frames may be exchanged on the first RF band that schedule the medium time intervals 302 for communication between the first wireless communication device and one or more second wireless communication devices (for example, STAs 104 which may be non-AP MLDs as described with reference to FIG. 1) over the second RF band. For example, a first medium time interval 302-a and a second medium time interval 302-b on the second RF band may be scheduled via management frames exchanged via the first RF band. In some examples, the first medium time interval 302-a may include an ATP 304 at a beginning portion of the first medium time interval 302-a. In some examples, the first medium time interval 302-a may include one or more D-SPs 306. In some examples, the first medium time interval 302-a may include one or more O-SPs 308. In some examples, the first medium time interval 302-a may include one or more durations 310 available for contention-based access via the first RF band. As shown, the first medium time interval 302-a may include a first duration 310-a available for contention-based access, a second duration 310-b available for contention-based access, a third duration 310-c available for contention-based access, and/or a fourth duration 310-d available for contention-based access. For example, as durations between SPs (for example, D-SPs 306 and O-SPs 308) may be available for contention-based access via the first RF band, time resources within the first medium time interval 302-a that may otherwise be unused for communication may be used for contention-based access transmission opportunities.

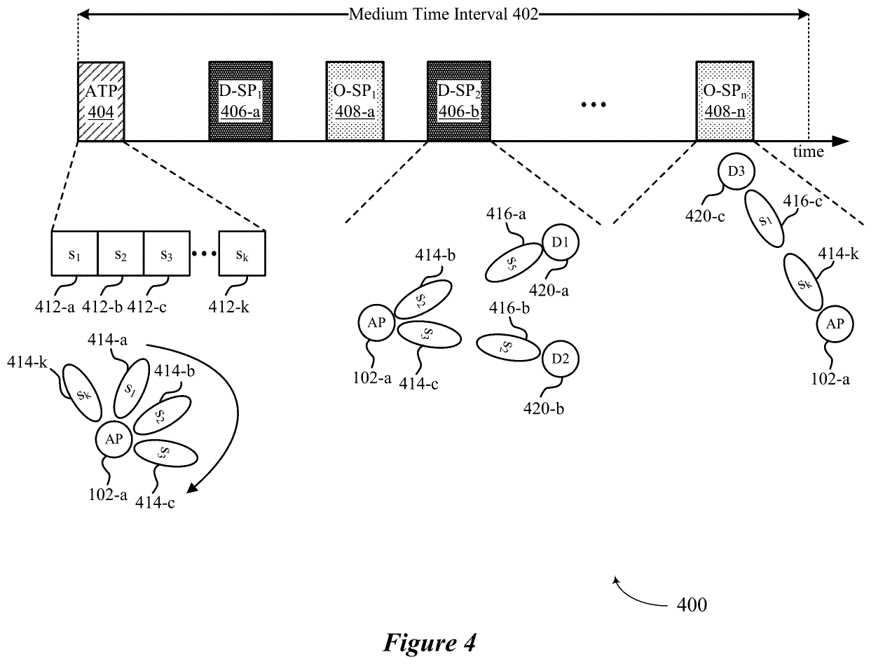

FIG. 4 shows an example of a medium time interval diagram 400 that includes shared D-SPs that supports channel access techniques for multi-band operation. In some examples, the medium time interval diagram 400 may implement or may be implemented by aspects of the wireless communication network 100 and/or the medium time interval diagram 300. For example, wireless communication devices such as APs 102 and/or STAs 104 in a WLAN may be capable of MLO. For example, the medium time interval diagram 400 includes an AP 102-a which may be an example of an AP 102 as described with reference to FIG. 1. As another example, the medium time interval diagram 400 includes a first wireless communication device 420-a, a second wireless communication device 420-b, and a third wireless communication device 420-c, which may be examples of non-AP MLDs, such as STAs 104 as described with reference to FIG. 1. As another example, the medium time interval 402 may be an example of a medium time interval 302 as described with reference to FIG. 3.

The AP 102-a may use a first RF band to set up the medium time intervals 402 for a second RF band. As shown in FIG. 4, the medium time interval 402 may include an ATP 404 at a beginning portion of the medium time interval 402. The ATP 404 may be an example of an ATP 304 as described with reference to FIG. 3. In some examples, the medium time interval 402 may include one or more D-SPs 406, which may be examples of D-SPs 306 as described with reference to FIG. 3. For example, as shown in FIG. 4, the medium time interval 402 may include a first D-SP 406-a and a second D-SP 406-b. In some examples, the medium time interval 402 may include one or more O-SPs 408, which may be examples of O-SPs as described with reference to FIG. 3. For example, as shown in FIG. 4, the medium time interval 402 may include a first O-SP 408-a and an nth O-SP 408-n.

In some examples, during the ATP, an AP 102-a may transmit one or more ASR frames 412 via corresponding sectorized beams 414. For example, a first ASR frame 412-a may be transmitted via a first beam 414-a, a second ASR frame 412-b may be transmitted via a second beam 414-b, a third ASR frame 412-c may be transmitted via a third beam 414-c, and a kth ASR frame 412-k may be transmitted via a kth beam 414-k. In some examples, the ASR frames 412 may be used to perform a beam training procedure between the AP 102-a and one or more of the first wireless communication device 420-a, the second wireless communication device 420-b, or the third wireless communication device 420-c. For example, the beams 414 may be transmitted in different beamformed directions during different beam training resources. The different sectors may be denoted as s₁, s₂, s₃, . . . , sₖ. In some examples, the ASR frames 412 may carry the sector information (for example, s₁, s₂, s₃, . . . , sₖ) associated with the given frames. In some examples, the ASR frames 412 may carry additional information such as the BSSID of the AP 102-a or the BSS color of the AP 102-a. In some examples, the ASR frames 412 may be short (such as 1 μs) symbol transmissions. In some examples, the ASR frames 412 may be a PHY header PPDU (such as a null data packet (NDP)). In some examples, the ASR frames 412 may be used as a reference for the non-AP devices (for example, the first wireless communication device 420-a, the second wireless communication device 420-b, and/or the third wireless communication device 420-c) to make beam training decisions. In some examples, a non-AP device (for example, the first wireless communication device 420-a, the second wireless communication device 420-b, and/or the third wireless communication device 420-c) may initiate beam training if the non-AP device does not receive an ASR frame 412 or if an ASR frame 412 is received at an RSSI below a threshold level.

In some examples, ASR frames 412 may not be included in each medium time interval. For example, a subsequent medium time interval for the second RF band after the medium time interval 402 may not include an ATP 404, which may reduce control overhead. As another example, frequent sector reference frames may not be demanded in static or low mobility technologies or use-cases. The AP 102-a may use the first RF band to provide details regarding the ATP 404 in the medium time interval 402 for the second RF band. For example, the details provided for the ATP 404 via the first RF band may include timing information for the ATP 404 (such as the presence or absence of the ATP 404, the periodicity or pattern of which medium time intervals include ATPs 404, the number of sectors in an ATP 404, and/or the duration of an ATP 404). In some examples, if a medium time interval does not include an ATP 404, the time resources that would otherwise be used for the ATP 404 may be used for a D-SP, an O-SP, or a duration for contention-based access (for example, via the first RF band).

As shown in FIG. 4, the second D-SP 406-b may be shared between the first wireless communication device 420-a and the second wireless communication device 420-b. For example, the second RF band may be highly directional and may support spatial division multiplexing (SDM). As SDM may be supported, during the second D-SP 406-b, the AP 102-a may serve the first wireless communication device 420-a via the second beam 414-b (for example, the first wireless communication device 420-a may be located in the second sector s₂ which may correspond to a fifth sector for the first wireless communication device 420-a) which may correspond to a beam 416-a at the first wireless communication device 420-a. Further, during the second D-SP 406-b, the AP 102-a may serve the second wireless communication device 420-b via the third beam 414-c (for example, the second wireless communication device 420-b may be located in the third sector s₃ which may correspond to a second sector for the second wireless communication device 420-b) which may correspond to a beam 416-b at the second wireless communication device 420-b.

In some examples, the AP 102-a and the wireless communication devices 420 (for example, the first wireless communication device 420-a, the second wireless communication device 420-b, and/or the third wireless communication device 420-c) may use the first RF band to negotiate or establish the D-SPs 406 within the medium time interval 402 for communication on the second RF band. For example, the D-SPs 406 may be set up via TWT setup frames exchanged on the first RF band. In some examples, one or more parameters of the D-SPs 406 may be set up, negotiated, or indicated via the first RF band. For example, the one or more parameters may include SP duration, periodicity (for example, the D-SPs 406 may be periodic), frame exchanges allowed during D-SPs 406, signaling for early SP termination and/or expansion, signaling for SP suspension, signaling for SP resumption, signaling for termination of a communication session, estimated load, and/or allocation of users (for example, order, priority, restrictions of traffic, or patterns).

In some examples, a D-SP may be shared between multiple wireless communication devices 420, for example, as shown in FIG. 4 with reference to the second D-SP 406-b. In some examples, a D-SP 406 may be configured as an individual D-SP (for example, for communication between the AP 102-a and a single wireless communication device 420). In some examples, whether a D-SP 406 is shared or individual may depend on traffic priority. In some examples, the AP 102-a may indicate a schedule of a set of shared D-SPs 406 within the medium time interval 402 via a broadcast indication or via an indication transmitted and addressed to the wireless communication devices which will be serviced during the set of shared D-SPs 406. For example, the AP 102-a may indicate the schedule of the set of shared D-SPs 406 as a set of broadcast TWTs (bTWTs). In some examples, the AP 102-a may indicate a schedule of a set of individual D-SPs 406 within the medium time interval 402 via an individual indication to a single wireless communication device 420 that will be serviced during the individual D-SP 406. For example, the AP 102-a may indicate the schedule of the set of individual D-SPs 406 as a set of individual TWTs (iTWTs) (for example, a TWT for a single wireless communication device 420) for the serviced wireless communication device.

In some examples, the AP 102-a may advertise, via the first RF band, schedules of shared D-SPs 406 on the second RF band within the medium time interval 402. Such advertisement via the first RF band may allow the wireless communication devices 420 to identify existing schedules for the second RF band. For example, the schedules may be advertised via the first RF band as bTWTs or iTWTs for the second RF band. For example, a wireless communication device 420 may perform association with the AP 102-a via frame exchanges on the first RF band and may use the first RF band to perform setup for the D-SPs 406 on the second RF band (for example, via frame exchanges on the first RF band). In some examples, each shared D-SP 406 may have an ID (for example, a bTWT ID) that uniquely identifies the shared D-SP 406. For example, the AP 102-a may identify a particular shared D-SP 406 in a frame exchange on the first RF band using the ID for the second RF band and the ID for the particular shared D-SP 406. For example, in an example in which a shared D-SP is a bTWT, the ID for the particular shared D-SP 406 may identify the bTWT on the second RF band.

During a shared D-SP 406, a participating wireless communication device 420 may orient its beam towards the AP 102-a. For example, for the second D-SP 406-b, the first wireless communication device 420-a may use the beam 416-a which is directed toward the AP 102-a and the second wireless communication device 420-b may use the beam 416-b which is directed toward the AP 102-a. In some examples, for a given shared D-SP 406, the AP 102-a may send individual frames to each wireless communication device 420 that the AP 102-a intends to service (for example, perform uplink or downlink communication with) during the given shared D-SP 406. For example, the AP 102-a may orient a beam 414 of the AP 102-a towards a wireless communication device 420 before transmitting an individually addressed frame to the wireless communication device 420. For example, for the second D-SP 406-b, the AP 102-a may use the second beam 414-b to transmit a frame to the first wireless communication device 420-a and the AP 102-a may use the third beam 414-c to transmit a frame to the second wireless communication device 420-b. Such an individually addressed frame may be an RTS, a MU-RTS, a buffer status report (BSR), or other frame. In some examples, the AP 102-a may determine which and how many wireless communication devices 420 to serve or poll in a given D-SP 406 based on traffic profiles and/or how many wireless communication devices 420 have responded to advertisement of the D-SP 406.

In some examples, if a wireless communication device 420 does not receive a frame within a time out period (for example, a threshold time period from a start of a D-SP 406), the wireless communication device 420 may assume that the AP 102-a will not service the wireless communication device 420 during that D-SP. For example, the frame may be a polling frame that indicates the AP 102-a intends to service the wireless communication device 420 during the D-SP 406. In such examples where the wireless communication device 420 does not receive a frame within a time out period, the wireless communication device 420 may operate in a power saving state or mode for the duration of the D-SP 406 (for example, until a next D-SP scheduled for the wireless communication device 420 is scheduled to begin). For example, the third wireless communication device 420-c may not receive a frame within the time out period for the second D-SP 406-b, and the third wireless communication device 420-c may operate in a power saving state or mode for the duration of the second D-SP 406-b. In some examples, the time out period may be indicated by the AP 102-a. For example, the time out period may be provided via an association response frame, a reassociation response frame, a beacon frame, a TWT setup frame, or another frame. In some examples, the time out period may be the same for all D-SPs 406 in the medium time interval 402. In some examples, the time out period may be for each D-SP 406 (for example, may be different for each D-SP 406). In some examples, the time out period may be computed as: (time for trigger frame transmission from the AP 102-a and response frame transmission from the wireless communication device 420)×(the quantity of wireless communication devices 420 indicated for service in the D-SP 406)+ (an allowance for channel access and/or possible retransmissions). In some examples, the time out period may be different for each wireless communication device 420 and/or may be based on the ordering of the wireless communication devices 420 within the D-SP 406. For example, a later ordered wireless communication device 420 may have a longer time out period. In such examples, the later ordered wireless communication device 420 may wake up at a later time to be served after the AP 102-a has served earlier ordered wireless communication devices 420.

In some examples, the wireless communication devices 420 that receive a frame from the AP 102-a within the time out period of a D-SP 406 may remain in an awake state or mode for at least a portion of the duration of the D-SP 406 to be serviced by the AP 102-a during the D-SP 406. For example, the first wireless communication device 420-a and the second wireless communication device 420-b may remain in the awake state or mode in the second D-SP 406-b to be serviced by the AP 102-a during the second D-SP 406-b. In some examples, the AP 102-a may transmit an indication to a wireless communication device 420 during a D-SP 406 that the AP does not intend to service the wireless communication device 420 for the remainder of the D-SP 406. In such examples, the wireless communication device 420 may operate in a power saving state or mode for the remainder of the D-SP 406. For example, such an indication may be an end of service period (EOSP) field in a frame transmitted to the wireless communication device 420 being set to “1” or a “more data” field in a frame transmitted to the wireless communication device 420 being set to “0.” In some examples, a wireless communication device 420 may indicate to the AP 102-a that the wireless communication device 420 is entering a power saving state or mode for a remainder of a D-SP 406 and will no longer participate in communication for the remainder of the D-SP 406. In some examples, a wireless communication device 420 may remain in an awake state or mode until the end of a SIFS separate frame exchange sequence.

In some examples, the AP 102-a may indicate via signaling on the first RF band that the AP 102-a does not intend to service a particular wireless communication device 420 during a particular D-SP 406. In such examples, the particular wireless communication device 420 may operate in a power saving state or mode for the duration of the corresponding D-SP 406. For example, the AP 102-a may indicate via signaling on the first RF band that the AP 102-a does not intend to service the third wireless communication device 420-c during the second D-SP 406-b, and the third wireless communication device 420-c may operate in a power saving state or mode for the duration of the second D-SP 406-b. In some examples, such signaling may be individually addressed to each particular wireless communication device 420 that will not be serviced. In some examples, such signaling may be group addressed to indicate multiple wireless communication devices 420 that will not be serviced. The particular D-SP may be identified by a corresponding ID (for example, a bTWT ID) for the D-SP and the ID for the second RF band.

In some examples, two or more wireless communication devices 420 may be served in a same D-SP 406 (a shared D-SP) in a time division multiplexing (TDM) manner (for example, the first wireless communication device 420-a and the second wireless communication device 420-b may be served in a TDM manner during the second D-SP 406-b). In some examples, two or more wireless communication devices 420 may be served in a same D-SP 406 (a shared D-SP) via the same beam 414 if the wireless communication devices 420 are physically close together (for example, in the same sector and/or the same beam 414 is able to be heard via both wireless communication devices 420 via OFDMA). In some examples, two or more wireless communication devices 420 may be served in a same D-SP 406 (a shared D-SP) in a frequency division multiplexing (FDM) manner over different frequency portions of the second RF band. For example, the AP 102-a may split RF or antenna resources across portions of the second RF band (for example, as subbands of the second RF band). In some examples, as shown in FIG. 4 with respect to the second D-SP 406-b, two or more wireless communication devices 420 may be served in a same D-SP 406 (a shared D-SP) via SDM. For example, different spatial streams may serve the first wireless communication device 420-a and the second wireless communication device 420-b during the second D-SP 406-b via the second beam 414-b and the third beam 414-c, respectively. For example, the AP 102-a may split antenna resources to form the different beams (for example, the second beam 414-b and the third beam 414-c) each directed to the different client devices (for example, the first wireless communication device 420-a and the second wireless communication device 420-b).

As shown in FIG. 4, the nth O-SP 408-n may be used for communication between the AP 102-a and the third wireless communication device 420-c. For example, during the nth O-SP 408-n, the AP 102-a may serve the third wireless communication device 420-c via the kth beam 414-k (for example, the third wireless communication device 420-c may be located in the kth sector sₖ which may correspond to a first sector for the third wireless communication device 420-c) which may correspond to a beam 416-c at the third wireless communication device 420-c. For example, the nth O-SP 408-n may be used to flush pending traffic (for example, buffered data) which was not serviced during a prior, D-SP 406, O-SP 408, or contention-based duration of the medium time interval 402, or which arrived during the medium time interval.

In some examples, O-SPs 408 may be scheduled or set up within the medium time interval 402 between successive D-SPs 406. The availability of O-SPs 408 on the second RF band may be advertised via signaling on the first RF band. For example, the O-SP scheduling information may be carried in a beacon frame or a follow-up beacon extension frame transmitted on the first RF band. In some examples, O-SPs 408 may be supplementary to D-SPs 406 and may provide additional time to flush pending traffic which could not be serviced during a D-SP 406. In some examples, a wireless communication device 420 may not subscribe to an O-SP 408. In some examples, the AP 102-a may determine if and/or when an O-SP 408 will be used and the AP 102-a may indicate, to the wireless communication device 420, which O-SP to use. For example, the AP 102-a may transmit an indication to the third wireless communication device 420-c to use to the nth O-SP 408-n. The indication of which O-SP 408 to use for a particular wireless communication device 420 may be signaled via the first RF band or the second RF band (for example, an indication signaled on the second RF band may be during an ongoing D-SP 406, an ongoing O-SP 408, or during a duration available for contention-based access). In some examples, a wireless communication device 420 may transmit a request to the AP 102-a (for example, via the first RF band or the second RF band) to use a particular O-SP 408 for frame exchanges between the AP 102-a and the wireless communication device 420. For example, the third wireless communication device 420-c may transmit a request to the AP 102-a to use the nth O-SP 408-n. Each O-SP 408 may have a unique ID (for example, a bTWT ID). On the first RF band, each O-SP 408 may be identified via the ID for the second RF band and the unique ID for the O-SP 408.

In some examples, the second RF band may be subject to high pathloss and transmissions on the second RF band may be highly directional. Highly directional transmissions on the second RF band may naturally apply spatial reuse. Channel access on the second RF band may be either scheduled (for example, initiated by the AP 102-a) or unscheduled and contention-based. In some examples, a NAV for the second RF band may not be used in transmissions (for example, if a transmission is not received or if access is scheduled via an SP or the first RF band). In some examples, the NAV for a transmission in the second RF band, which is scheduled or accessed via the first RF band, may be set to “0” or a fixed value to indicate “reserved.” In some examples, the NAV for a transmission in the second RF band, which is scheduled or accessed via the first RF band, may be set to indicate the duration of the corresponding TXOP. In such examples, the other wireless communication devices 420 may ignore the NAV setting for a transmission of a PPDU on the second RF band if the other wireless communication devices 420 successfully decode the PPDU.

In some examples, the second RF band (for example, a 60 GHz RF band) may support contention-based access on the second RF band, which may involve the use of a NAV. In such examples, for D-SPs and O-SPs, the NAV may be set to the duration of the D-SP or O-SP so that a wireless communication device that receives the NAV may defer until the end of the corresponding D-SP or O-SP. For contention-based access on the second RF band, the first RF band may indicate the duration of the TXOP on the second RF band so that the NAV may be set accordingly.

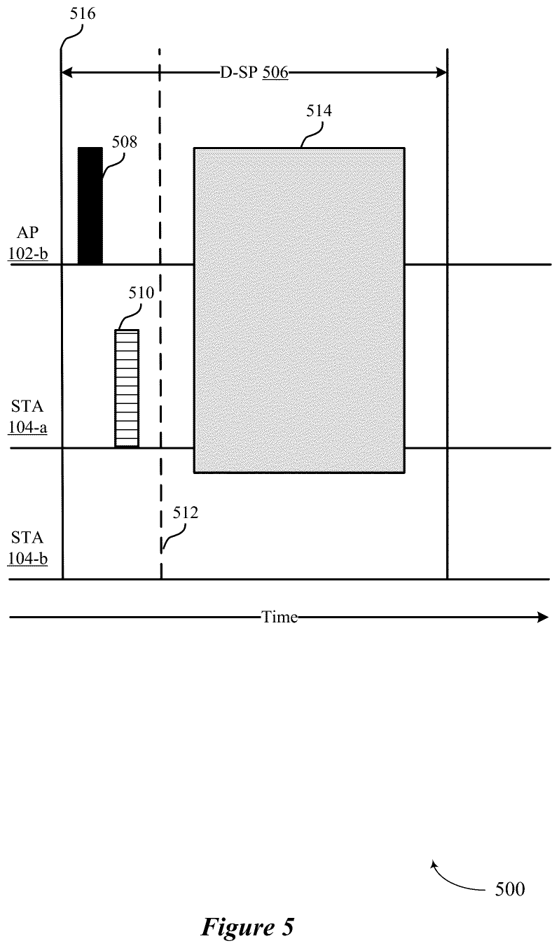

FIG. 5 shows an example of a communication timeline 500 for a D-SP that supports channel access techniques for multi-band operation. In some examples, the communication timeline 500 for a D-SP may implement or may be implemented by aspects of the wireless communication network 100, the medium time interval diagram 300, and/or the medium time interval diagram 400. For example, the D-SP 506 may be an example of a D-SP 306 as described with reference to FIG. 3 or a D-SP 406 as described with reference to FIG. 4. The AP 102-b may be an example of an AP 102 as described with reference to FIG. 1 or an AP 102-a as described with reference to FIG. 4. For example, the AP 102-b may be an AP MLD. The STA 104-a and the STA 104-b may be examples of STAs 104 described with reference to FIG. 1 or wireless communication devices 420 as described with reference to FIG. 4. For example, the STA 104-a and the STA 104-b may be non-AP MLDs.

The AP 102-b may indicate, via a first RF band, that the D-SP 506 on a second RF band is available for communication for the STA 104-a and the STA 104-b (for example, that the D-SP 506 is a shared D-SP). During the D-SP 506, the AP 102-b may transmit a polling frame 508 to the STA 104-a prior to an end 512 of a time out period with respect to the start 516 of the D-SP 506. For example, the polling frame 508 may be transmitted via the second RF band. The STA 104-a may transmit a response 510 to the polling frame 508. For example, the response 510 may be a trigger based PPDU. Based on the polling frame 508 and/or the response 510 being exchanged prior to the end 512 of the time out period, the AP 102-b and the STA 104-a may exchange one or more frames 514 (for example, for uplink or downlink communication) during the D-SP 506. Based on not receiving a polling frame prior to the end 512 of the time out period with respect to the start 516 of the D-SP 506, the STA 104-b may operate in a power saving state or mode for the remainder of the D-SP 506 (for example, the portion of the D-SP 506 after the end 512 of the time out period).

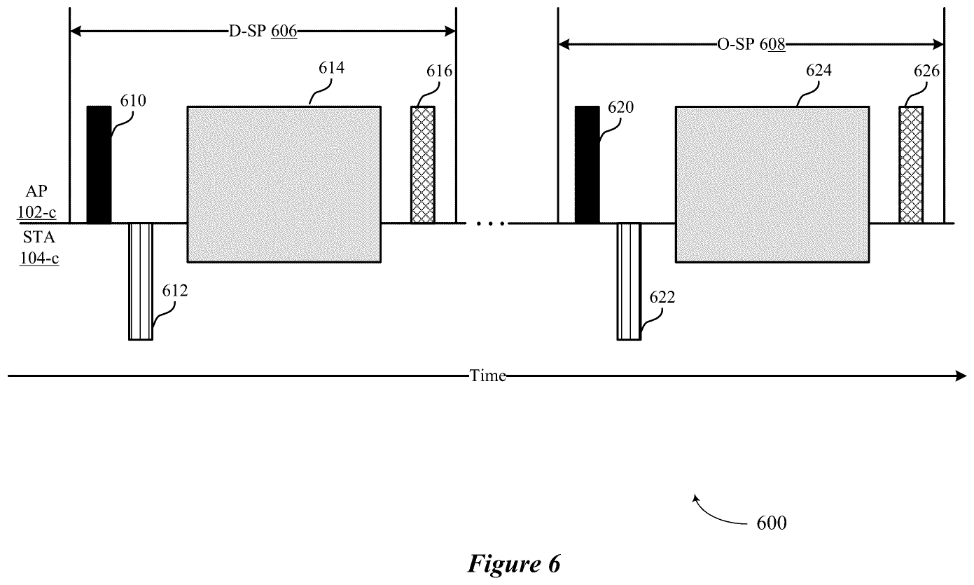

FIG. 6 shows an example of a communication timeline 600 for an O-SP that supports channel access techniques for multi-band operation. In some examples, the communication timeline 600 for an O-SP may implement or may be implemented by aspects of the wireless communication network 100, the medium time interval diagram 300, and/or the medium time interval diagram 400. For example, the D-SP 606 may be an example of a D-SP 306 as described with reference to FIG. 3 or a D-SP 406 as described with reference to FIG. 4. The O-SP 608 may be an example of an O-SP 308 as described with reference to FIG. 3 or an O-SP 408 as described with reference to FIG. 4. The AP 102-c may be an example of an AP 102 as described with reference to FIG. 1 or an AP 102-a as described with reference to FIG. 4. For example, the AP 102-c may be an AP MLD. The STA 104-c may be an example of a STA 104 described with reference to FIG. 1 or a wireless communication device 420 as described with reference to FIG. 4. For example, STA 104-c may be a non-AP MLD.

During the D-SP 606, the AP 102-c may transmit a polling frame 610 to the STA 104-c to indicate that the AP 102-c will service the STA 104-c during the D-SP 606. The STA 104-c may transmit a response 612 to the polling frame 610 to the AP 102-c. Based on the exchange of the polling frame 610 and the response 612, the AP 102-c and the STA 104-c may exchange one or more frames 614 (for example, for uplink or downlink communication) during the D-SP 606. At the end of the exchange of the one or more frames 614, the AP 102-c may have remaining traffic (for example, buffered data) for transmission to the STA 104-c, and/or the STA 104-c may have remaining traffic (for example, buffered data) for transmission to the AP 102-c. The AP 102-c may transmit a frame 616 indicating to resume communication between the AP 102-c and the STA 104-c in the O-SP 608. In some examples, the frame 616 may indicate the unique ID of the O-SP 608. In some examples, the STA 104-c may transmit a request to the AP 102-c to use an O-SP based on the STA 104-c having remaining traffic for transmission to the AP 102-c, and the AP 102-c may transmit the frame 616 in response to the request.

During the O-SP 608, the AP 102-c may transmit a polling frame 620 to the STA 104-c to indicate that the AP 102-c will service the STA 104-c during the O-SP 608. The STA 104-c may transmit a response 622 to the polling frame 620 to the AP 102-c. Based on the exchange of the polling frame 620 and the response 622, the AP 102-c and the STA 104-c may exchange one or more frames 624 (for example, for uplink or downlink communication) during the D-SP 606. At the end of the exchange of the one or more frames 624, the AP 102-c may have remaining traffic (for example, buffered data) for transmission to the STA 104-c, and/or the STA 104-c may have remaining traffic (for example, buffered data) for transmission to the AP 102-c. The AP 102-c may transmit a frame 626 indicating to resume communication between the AP 102-c and the STA 104-c in a subsequent O-SP.

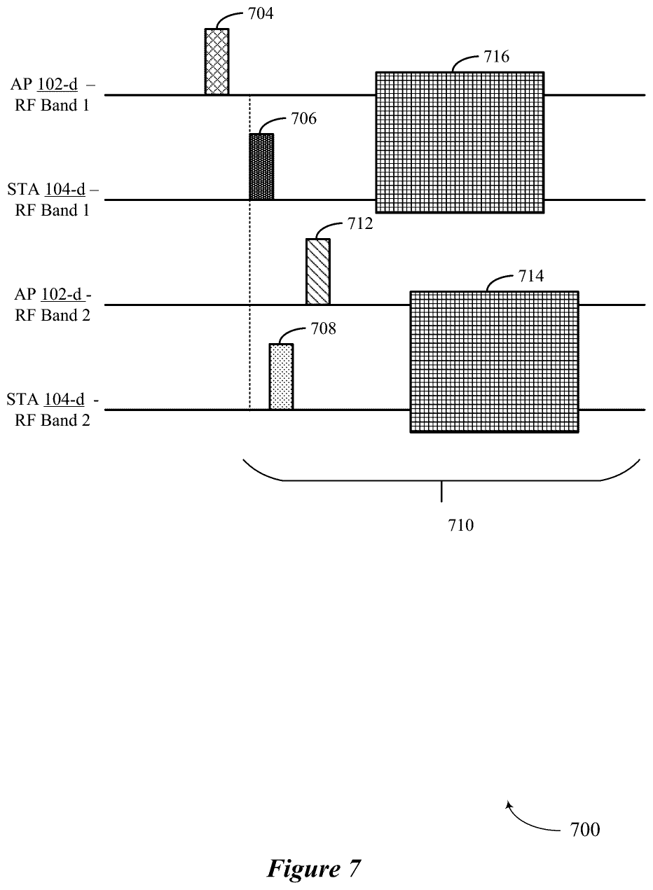

FIG. 7 shows an example of a contention-based access process 700 that supports channel access techniques for multi-band operation. In some examples, the contention-based access process 700 may implement or may be implemented by aspects of the wireless communication network 100, the medium time interval diagram 300, and/or the medium time interval diagram 400. For example, the AP 102-d may be an example of an AP 102 as described with reference to FIG. 1 or an AP 102-a as described with reference to FIG. 4. For example, the AP 102-d may be an AP MLD. The STA 104-d may be an example of a STA 104 described with reference to FIG. 1 or a wireless communication device 420 as described with reference to FIG. 4. For example, STA 104-d may be a non-AP MLD.

The AP 102-d may use a first RF band to set up one or more medium time intervals for a second RF band (for example, medium time intervals 302 as described with reference to FIG. 3). The medium time interval for the second RF band may include one or more durations 710 (for example, durations 310 as described with reference to FIG. 3) available for contention-based access via the first RF band. For example, the durations available for contention-based access via the first RF band may be scheduled in between scheduled SPs within the medium time interval.

In some examples, either the AP 102-d or the STA 104-d may transmit a frame via the first RF band to indicate interest (for example, to indicate a request to operate on the second RF band) in a given duration 710 available for contention-based access. For example, the AP 102-d may transmit a wake up signal 704 to the STA 104-d via the first RF band to indicate for the STA 104-d to wake up on the second RF band. Such a wake up signal 704 may be used to wake up any link (for example, a third link such as another sub7 link when the first RF band is a sub7 band, or other links on other bands such as 3.5 GHZ, 28 GHz, or 60 GHz). The wake up signal 704 may include the link ID of the RF band for which the AP 102-d requests the STA 104-d to wake up. In some examples, the STA 104-d may transmit the wake up signal 704 to the AP 102-d.

In some examples, the wake up signal 704 may indicate whether the AP 102-d and the STA 104-d will communicate during the duration 710 over both the first RF band and the second RF band or only over the second RF band. The STA 104-d may transmit a response 706 indicating an acceptance or rejection of the request to wake up for the second RF band indicated by the wake up signal 704. For example, the STA 104-d and the AP 102-d may communicate one or more frames 714 over the second RF band during the duration 710 and/or the STA 104-d and the AP 102-d may communicate one or more frames 716 over the first RF band during the duration 710. In some examples, if the response 706 indicates an acceptance, the response 706 may indicate whether the STA 104-d requests to communicate during the duration 710 over both the first RF band and the second RF band or only over the second RF band. For example, the STA 104-d may request to communicate during the duration 710 only over the second RF band for power-saving purposes or if resources on the first RF band during the duration 710 are shared with other devices. In some examples, the STA 104-d may request to communicate during the duration 710 only over the first RF band, for example, in an example in which the STA 104-d determines that the second RF band is out of range.

In some examples, communication between the AP 102-d and the STA 104-d during the duration 710 over both the first RF band and the second RF band may involve aligned transmissions between the first RF band and the second RF band. In some examples, the wake up signal 704 may be a control frame such as a trigger frame, and RTS frame, or an MU-RTS frame. In some examples, the wake up signal 704 may be an indication carried in the A-Control field of a data or management frame. In some examples, the wake up signal 704 may be an NDP PPDU. In such examples, the wake-up information may be carried in the PHY header of the PPDU.

In some examples, if the STA 104-d transmits the response 706 indicating acceptance of the request to wake up for the second RF band indicated by the wake up signal 704, the STA 104-d may transmit a frame 708 on the second RF band indicating that the STA 104-d is available on the second RF band. For example, the STA 104-d may demand additional time to wake up on the second RF band or to tune a beam to the second RF band. The frame 708 may serve as a confirmation that the STA 104-d is ready to communicate on the second RF band. In some examples, the frame 708 may serve as a reference to check whether beam training or beam refinement is demanded. For example, beam training or refinement may be initiated if the frame 708 is not received by the AP 102-d within a time out period or is received at an RSSI below a threshold. In some examples, if the STA 104-d transmits the response 706 indicating acceptance of the request to wake up for the second RF band indicated by the wake up signal 704, the AP 102-d may transmit a frame 712 on the second RF band indicating that the AP 102-d is available on the second RF band.

In some examples (for example, instead of transmission of the frame 708), each of the STA 104-d and the AP 102-d may provide, during association frame exchange, information about a time to wake up on the second RF band. In some examples, the STA 104-d may wait until the time indicated by the AP 102-d before performing any frame exchange with the AP 102-d, and/or the AP 102-d may wait until the time indicated by the STA 104-d before performing any frame exchange with the STA 104-d. In some examples, the response 706 may indicate the wake up delay for the second RF band for the STA 104-d.

In some examples, the STA 104-d may transmit the wake up signal 704 and the AP 102-d may transmit the response 706. In such examples, the AP 102-d may transmit the frame 708.

In some examples, cross-channel link access (for example, using the first RF band to perform contention-based access for the second RF band) may not be initiated by the STA 104-d if the duration 710 overlaps with an SP (for example, a D-SP or an O-SP) announced by the AP 102-d. In such examples, the AP 102-d may initiate cross-channel link access (for example, during a scheduled D-SP on the second RF band) if the STA 104-d is a participant of the D-SP and the time out period (which may be specified either implicitly or explicitly) passed for that D-SP. In some examples, the wake up signal 704 for contention-based access may align with an O-SP on the second RF band and may include the ID for the O-SP. For example, the AP 102-d may request via the wake up signal 704 for the STA 104-d to wake up during an O-SP on the second RF band. In some examples, the frame exchange on the first RF band may indicate or negotiate the duration of the TXOP for transmission of the one or more frames 714 over the second RF band. In some examples, the frame exchange on the first RF band (for example, the wake up signal 704) may indicate or negotiate parameters for transmission of the one or more frames 714 over the second RF band, such as bandwidth, MCS, and/or the number of spatial streams (N_{SS}).

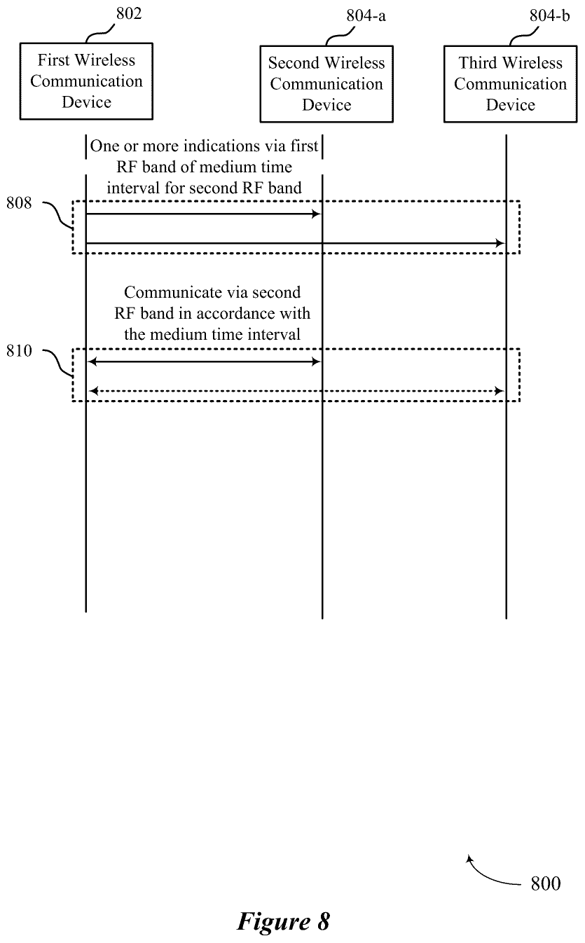

FIG. 8 shows an example of a process flow 800 that supports channel access techniques for multi-band operation. In some examples, the process flow 800 may implement or may be implemented by aspects of the wireless communication network 100, the medium time interval diagram 300, the medium time interval diagram 400, the communication timeline 500, the communication timeline 600, and/or the contention-based access process 700. The process flow 800 may illustrate an example of a first wireless communication device 802, which may be an example of an AP 102 as described with reference to FIG. 1, an AP 102-a as described with reference to FIG. 4, an AP 102-b as described with reference to FIG. 5, an AP 102-c as described with reference to FIG. 6, or an AP 102-d as described with reference to FIG. 7. For example, the first wireless communication device 802 may be an AP MLD. The process flow 800 may further illustrate examples of a second wireless communication device 804-a and a third wireless communication device 804-b, which may be examples of STAs 104 as described with reference to FIG. 1, wireless communication devices 420 as described with reference to FIG. 4, STAs 104-a and 104-b as described with reference to FIG. 5, a STA 104-c as described with reference to FIG. 6, or a STA 104-d as described with reference to FIG. 7. For example, the second wireless communication device 804-a and the third wireless communication device 804-b may be non-AP MLDs. In the following description of the process flow 800, the communications between the first wireless communication device 802, the second wireless communication device 804-a, and the third wireless communication device 804-b may be transmitted in a different order than the example order shown, or the operations performed by the first wireless communication device 802, the second wireless communication device 804-a, and the third wireless communication device 804-b may be performed in different orders or at different times. Some operations also may be omitted from the process flow 800, and other operations may be added to the process flow 800.

At 808, the first wireless communication device 802 may transmit, via a first RF band, one or more indications of a medium time interval for a second RF band that is different than the first RF band. The second wireless communication device 804-a and/or the third wireless communication device 804-b may receive the one or more indications of the medium time interval. The one or more indications may include one or more of: an indication of one or more shared D-SPs for communication on the second RF band with a first set of two or more second wireless communication devices via TDM, FDM, or SDM; an indication of one or more O-SPs available for allocation by the first wireless communication device to a second set of one or more second wireless communication devices during the medium time interval in association with pending buffered data to transmit that arrived during the medium time interval and before a start of the one or more O-SPs; or an indication of one or more durations of the medium time interval available for a third set of one or more second wireless communication devices for contention-based access via the first RF band. In some examples, each of the one or more durations is positioned within the medium time interval between the one or more shared D-SPs, the one or more O-SPs, or one or more individual D-SPs.

At 810, the first wireless communication device 802 may communicate, via the second RF band and in accordance with the medium time interval, with the second wireless communication device 804-a. The second wireless communication device 804-a may be included in at least one of the first set of two or more second wireless communication devices, the second set of one or more second wireless communication devices, or the third set of one or more second wireless communication devices.

In some examples, the first wireless communication device 802 may transmit, over a temporally first portion of the medium time interval and via the second RF band, a reference frame for the medium time interval. In such examples, the one or more indications of the medium time interval may include an indication of a timing of the reference frame for the medium time interval. In some examples, the reference frame may be an ASR, and the temporally first portion may be an ATP. In some examples, the first wireless communication device 802 may transmit, via the first RF band, one or more second indications of a second medium time interval for the second RF band, the one or more second indications including an indication that the second medium time interval omits a reference frame for the second medium time interval at a temporal beginning of the second medium time interval. In some examples, the one or more second indications of the second medium time interval may include an indication that the second medium time interval includes, over the temporally first portion of the second medium time interval: a D-SP for communication on the second RF band with a fourth set of one or more second wireless communication devices; or a second duration for the second RF band available for a fifth set of one or more second wireless communication devices for contention-based access via the first RF band.

In some examples, transmission of the one or more indications of the medium time interval at 808 may include transmission of an indication of one or more parameters associated with the one or more shared D-SPs, the one or more parameters including a SP duration, a periodicity, supported frame types, a signaling type for SP termination, a signaling type for SP expansion, a signaling type for SP suspension, a signaling type for SP resumption after suspension, an estimated load, an allocation of users, or a combination thereof.

In some examples, transmission of the one or more indications of the medium time interval at 808 may include transmission of an indication of an individual D-SP for communication with only the first wireless communication device 802 and the second wireless communication device 804-a.

In some examples, the first wireless communication device 802 may transmit, via the first RF band, a frame advertising an availability of a set of D-SPs within the medium time interval, the set of D-SPs including the one or more shared D-SPs. In such examples, the first wireless communication device 802 may receive, via the first RF band from the second wireless communication device and responsive to the frame, a request to use the one or more shared D-SPs, transmission of the one or more indications of the medium time interval is in association with reception of the request, and the first set of two or more second wireless communication devices includes the second wireless communication device 804-a.

In some examples, the first wireless communication device 802 may receive, via the first RF band from the second wireless communication device 804-a, a request for establishing the one or more shared D-SPs on the second RF band, and transmission of the one or more indications of the medium time interval is in association with reception of the request.

In some examples, communicating with the second wireless communication device 804-a may include: transmitting to the second wireless communication device and via the second RF band, a frame including an indication that the first wireless communication device 802 intends to service the second wireless communication device 804-a over a first shared D-SP of the one or more shared D-SPs; and communicating data with the second wireless communication device 804-a over the first shared D-SP via the second RF band in association with transmission of the frame. In some examples, the first wireless communication device 802 may transmit the frame within a threshold time period of a temporal beginning of the first shared D-SP, and transmission of the frame within the threshold time period may be the indication that the first wireless communication device intends to service the second wireless communication device 804-a over the first shared D-SP. In some examples, the first wireless communication device 802 may transmit, to the third wireless communication device 804-b and via the first RF band, a second frame that includes an indication that the first wireless communication device does not intend to service the third wireless communication device 804-b over the first shared D-SP. The third wireless communication device 804-b may operate, in association with reception of the second frame, in a power saving mode over the first shared D-SP.

In some examples, transmission of the one or more indications of the medium time interval at 808 may include transmission of the indication of the one or more O-SPs, and communicating with the second wireless communication device 804-a may involve communicating with the second wireless communication device 804-a over a first O-SP of the one or more O-SPs. In some examples, the first wireless communication device 802 may receive, from the second wireless communication device 804-a, a request to use the first O-SP, and communication with the second wireless communication device 804-a over the first O-SP is in association with reception of the request.

In some examples, the first wireless communication device 802 may communicate, with the second wireless communication device 804-a and via the first RF band, a request to use a first duration of the one or more durations on the second RF band for communication between the first wireless communication device 802 and the second wireless communication device 804-a. In such examples, the first wireless communication device 802 may communicate, with the second wireless communication device 804-a via the first RF band and in association with communication of the request, a response that indicates an intention to use the second RF band for the first duration for communication between the first wireless communication device 802 and the second wireless communication device 804-a. In some examples, communicating the response may include communicating an indication of an intention to use both the first RF band and the second RF band for the first duration for the communication between the first wireless communication device 802 and the second wireless communication device 804-a. In some examples, communicating the response may include communicating an indication of an intention to use the first RF band for the first duration for the communication between the first wireless communication device 802 and the second wireless communication device 804-a. In some examples, the first wireless communication device 802 may communicate, with the third wireless communication device 804-b and via the first RF band, a second request to use the first duration for communication between the first wireless communication device 802 and the third wireless communication device 804-b. In such examples, the first wireless communication device 802 may transmit, to the third wireless communication device 804-b via the first RF band and in association with communication of the second request, a second response that indicates that the first wireless communication device 802 does not intend to use the second RF band for the first duration for communication between the first wireless communication device 802 and the third wireless communication device 804-b in association with transmission of the response.

In some examples, communicating with the second wireless communication device 804-a may include setting a network allocation vector to a fixed value for communication via the second RF band with the second wireless communication device 804-a.

In some examples, the first wireless communication device 802 may receive, from the second wireless communication device 804-a and via the first RF band, an indication of a capability of the second wireless communication device 804-a to support one or more modes of channel access on the second RF band via the first RF band, a first mode of the one or more modes being indication via the first RF band of the one or more shared D-SPs on the second RF band, a second mode of the one or more modes being contention for access of the one or more durations via the first RF band, and transmission of the one or more indications of the medium time interval is in association with reception of the indication of the capability.

In some examples, communicating with at least one of the second wireless communication device 804-a or the third wireless communication device 804-b at 810 may include communicating with the second wireless communication device 804-a and the third wireless communication device 804-b over a first shared D-SP of the one or more shared D-SPs via FDM, TDM, or SDM. For example, the first wireless communication device 802 may communicate over the first shared D-SP via TDM with the second wireless communication device 804-a and the third wireless communication device 804-b via using a first subset of time resources of the first shared D-SP to communicate with the second wireless communication device 804-a and a second subset of time resources of the first shared D-SP to communicate with the third wireless communication device 804-b. As another example, the first wireless communication device 802 may communicate over the first shared D-SP via FDM with the second wireless communication device 804-a and the third wireless communication device 804-b via using a first subset of frequency resources (for example, a first subband) of the first shared D-SP to communicate with the second wireless communication device 804-a and a second subset of frequency resources (for example, a second subband) of the first shared D-SP to communicate with the third wireless communication device 804-b. As another example, the first wireless communication device 802 may communicate over the first shared D-SP via SDM via splitting antenna resources to form different beams to serve the second wireless communication device 804-a and the third wireless communication device 804-b.

In some examples, the pending buffered data arrived after the one or more shared D-SPs, the one or more durations for contention based access, or one or more individual D-SPs of the medium time interval.

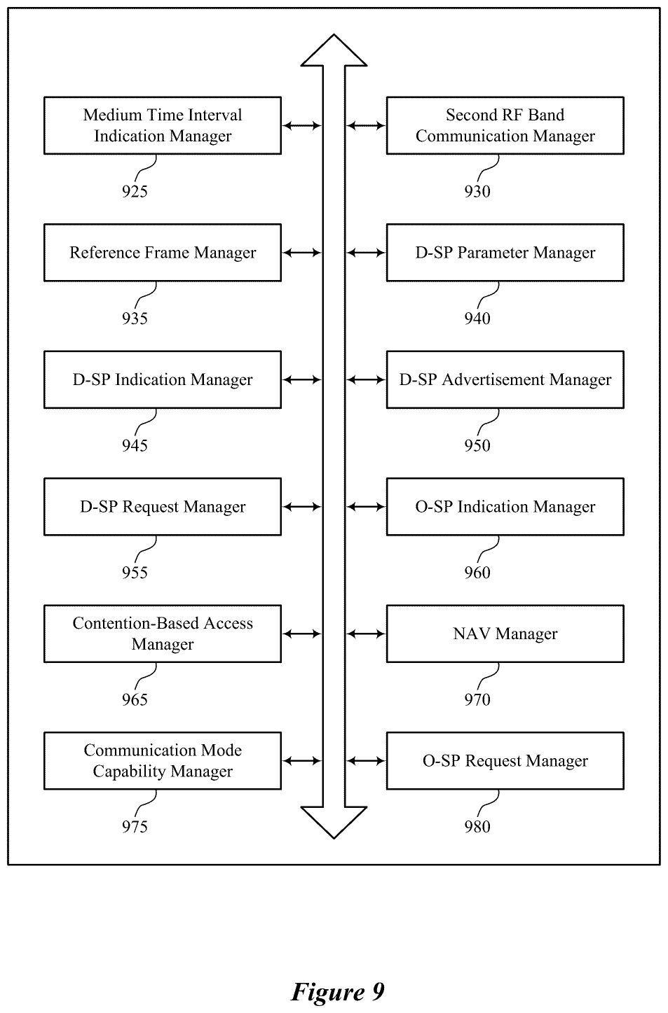

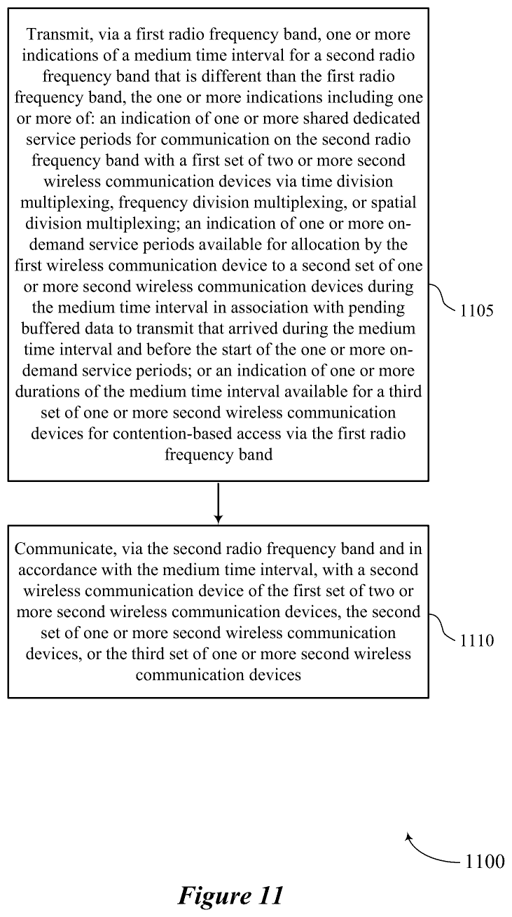

FIG. 9 shows a block diagram of an example first wireless communication device that supports channel access techniques for multi-band operation. In some examples, the first wireless communication device is configured to perform the process 1100 described with reference to FIG. 11. The first wireless communication device may include one or more chips, SoCs, chipsets, packages, components or devices that individually or collectively constitute or include a processing system. The processing system may interface with other components of the first wireless communication device, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the first wireless communication device may transmit the information output from the chip. In such an example, the second interface may refer to an interface between the processing system of the chip and a reception component, such that the first wireless communication device may receive information that is then passed to the processing system. In some such examples, the first interface also may obtain information, such as from the transmission component, and the second interface also may output information, such as to the reception component.

The processing system of the first wireless communication device includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the first wireless communication device can be configurable or configured for use in an AP, such as the AP 102 described with reference to FIG. 1. In some other examples, the first wireless communication device can be an AP that includes such a processing system and other components including multiple antennas. The first wireless communication device is capable of transmitting and receiving wireless communications in the form of, for example, wireless packets. For example, the first wireless communication device can be configurable or configured to transmit and receive packets in the form of physical layer PPDUs and MPDUs conforming to one or more of the IEEE 802.11 family of wireless communication protocol standards. In some other examples, the first wireless communication device can be configurable or configured to transmit and receive signals and communications conforming to one or more 3GPP specifications including those for 5G NR or 6G. In some examples, the first wireless communication device also includes or can be coupled with one or more application processors which may be further coupled with one or more other memories. In some examples, the first wireless communication device further includes at least one external network interface coupled with the processing system that enables communication with a core network or backhaul network that enables the first wireless communication device to gain access to external networks including the Internet.

The first wireless communication device includes a medium time interval indication manager 925, a second RF band communication manager 930, a reference frame manager 935, a D-SP parameter manager 940, a D-SP indication manager 945, a D-SP advertisement manager 950, a D-SP request manager 955, an O-SP indication manager 960, a contention-based access manager 965, a NAV manager 970, a communication mode capability manager 975, and an O-SP request manager 980. Portions of one or more of the medium time interval indication manager 925, the second RF band communication manager 930, the reference frame manager 935, the D-SP parameter manager 940, the D-SP indication manager 945, the D-SP advertisement manager 950, the D-SP request manager 955, the O-SP indication manager 960, the contention-based access manager 965, the NAV manager 970, the communication mode capability manager 975, and the O-SP request manager 980 may be implemented at least in part in hardware or firmware. For example, one or more of the medium time interval indication manager 925, the second RF band communication manager 930, the reference frame manager 935, the D-SP parameter manager 940, the D-SP indication manager 945, the D-SP advertisement manager 950, the D-SP request manager 955, the O-SP indication manager 960, the contention-based access manager 965, the NAV manager 970, the communication mode capability manager 975, and the O-SP request manager 980 may be implemented at least in part by at least a processor or a modem. In some examples, portions of one or more of the medium time interval indication manager 925, the second RF band communication manager 930, the reference frame manager 935, the D-SP parameter manager 940, the D-SP indication manager 945, the D-SP advertisement manager 950, the D-SP request manager 955, the O-SP indication manager 960, the contention-based access manager 965, the NAV manager 970, the communication mode capability manager 975, and the O-SP request manager 980 may be implemented at least in part by a processor and software in the form of processor-executable code stored in memory.

The first wireless communication device may support wireless communication performed in accordance with examples as disclosed herein. The medium time interval indication manager 925 is configurable or configured to transmit, via a first RF band, one or more indications of a medium time interval for a second RF band that is different than the first RF band, the one or more indications including one or more of: an indication of one or more shared D-SPs for communication on the second RF band with a first set of two or more second wireless communication devices via TDM, FDM, or SDM; an indication of one or more O-SPs available for allocation by the first wireless communication device to a second set of one or more second wireless communication devices during the medium time interval in association with pending buffered data to transmit that arrived during the medium time interval and before a start of the one or more O-SPs; or an indication of one or more durations of the medium time interval available for a third set of one or more second wireless communication devices for contention-based access via the first RF band. The second RF band communication manager 930 is configurable or configured to communicate, via the second RF band and in accordance with the medium time interval, with a second wireless communication device of the first set of two or more second wireless communication devices, the second set of one or more second wireless communication devices, or the third set of one or more second wireless communication devices.

In some examples, the reference frame manager 935 is configurable or configured to transmit, over a temporally-first portion of the medium time interval and via the second RF band, a reference frame for the medium time interval, where the one or more indications of the medium time interval further include an indication of a timing of the reference frame for the medium time interval.

In some examples, the medium time interval indication manager 925 is configurable or configured to transmit, via the first RF band, one or more second indications of a second medium time interval for the second RF band, the one or more second indications including an indication that the second medium time interval omits a reference frame for the second medium time interval at a second temporally first portion of the second medium time interval.

In some examples, the one or more second indications of the second medium time interval include an indication that the second medium time interval includes, over the second temporally first portion of the second medium time interval: a D-SP for communication on the second RF band with a fourth set of one or more second wireless communication devices; or a second duration for the second RF band available for a fifth set of one or more second wireless communication devices for contention-based access via the first RF band.

In some examples, to support transmitting the one or more indications of the medium time interval, the D-SP parameter manager 940 is configurable or configured to transmit an indication of one or more parameters associated with the one or more shared D-SPs, the one or more parameters including a SP duration, a periodicity, supported frame types, a signaling type for SP termination, a signaling type for SP expansion, a signaling type for SP suspension, a signaling type for SP resumption after suspension, an estimated load, an allocation of users, or a combination thereof.

In some examples, to support transmitting the one or more indications of the medium time interval, the D-SP indication manager 945 is configurable or configured to transmit an indication of an individual D-SP for communication with only the first wireless communication device and the second wireless communication device.

In some examples, the D-SP advertisement manager 950 is configurable or configured to transmit, via the first RF band, a frame advertising an availability of a set of D-SPs within the medium time interval, the set of D-SPs including the one or more shared D-SPs. In some examples, the D-SP request manager 955 is configurable or configured to receive, via the first RF band from the second wireless communication device and responsive to the frame, a request to use the one or more shared D-SPs, where transmission of the one or more indications of the medium time interval is in association with reception of the request, and where the first set of two or more second wireless communication devices includes the second wireless communication device.

In some examples, the D-SP request manager 955 is configurable or configured to receive, via the first RF band from the second wireless communication device, a request for establishing the one or more shared D-SPs on the second RF band, where transmission of the one or more indications of the medium time interval is in association with reception of the request.

In some examples, to support communicating with the second wireless communication device, the D-SP indication manager 945 is configurable or configured to transmit, to the second wireless communication device and via the second RF band, a frame including an indication that the first wireless communication device intends to service the second wireless communication device over a first shared D-SP of the one or more shared D-SPs. In some examples, to support communicating with the second wireless communication device, the second RF band communication manager 930 is configurable or configured to communicate data with the second wireless communication device over the first shared D-SP via the second RF band in association with transmission of the frame.

In some examples, the D-SP indication manager 945 is configurable or configured to transmit, to a third wireless communication device and via the first RF band, a second frame including an indication that the first wireless communication device does not intend to service the third wireless communication device over the first shared D-SP.

In some examples, to support transmitting the frame, the D-SP indication manager 945 is configurable or configured to transmit the frame within a threshold time period of a temporal beginning of the first shared D-SP, where transmission of the frame within the threshold time period includes the indication that the first wireless communication device intends to service the second wireless communication device over the first shared D-SP.

In some examples, to support transmitting the one or more indications of the medium time interval, the O-SP indication manager 960 is configurable or configured to transmit the indication of the one or more O-SPs, where communicating with the second wireless communication device includes communicating with the second wireless communication device over a first O-SP of the one or more O-SPs.

In some examples, the O-SP request manager 980 is configurable or configured to receive, from the second wireless communication device, a request to use the first O-SP, where communication with the second wireless communication device over the first O-SP is in association with reception of the request.

In some examples, the contention-based access manager 965 is configurable or configured to communicate, with the second wireless communication device and via the first RF band, a request to use a first duration of the one or more durations on the second RF band for communication with the second wireless communication device. In some examples, the contention-based access manager 965 is configurable or configured to communicate, with the second wireless communication device via the first RF band and in association with communication of the request, a response that indicates an intention to use the second RF band for the first duration for communication with the second wireless communication device.

In some examples, to support communicating the response, the contention-based access manager 965 is configurable or configured to communicate an indication of an intention to use both the first RF band and the second RF band for the first duration for the communication with the second wireless communication device.

In some examples, the contention-based access manager 965 is configurable or configured to communicate, with the second wireless communication device and via the first RF band, a request to use a first duration of the one or more durations on the second RF band for communication with the second wireless communication device. In some examples, the contention-based access manager 965 is configurable or configured to communicate, with the second wireless communication device via the first RF band and in association with communication of the request, a response that indicates an intention to use the first RF band for the first duration for communication with the second wireless communication device.

In some examples, the contention-based access manager 965 is configurable or configured to communicate, with a third wireless communication device and via the first RF band, a second request to use the first duration for communication with the third wireless communication device. In some examples, the contention-based access manager 965 is configurable or configured to transmit, to the third wireless communication device via the first RF band and in association with communication of the second request, a second response that indicates that the first wireless communication device does not intend to use the second RF band for the first duration for communication with the third wireless communication device in association with transmission of the response, the third wireless communication device being one of the third set of one or more second wireless communication devices.

In some examples, to support communicating with the second wireless communication device, the NAV manager 970 is configurable or configured to set a network allocation vector to a fixed value for communication via the second RF band with the second wireless communication device.

In some examples, the communication mode capability manager 975 is configurable or configured to receive, from the second wireless communication device and via the first RF band, an indication of a capability of the second wireless communication device to support one or more modes of channel access on the second RF band via the first RF band, a first mode of the one or more modes being indication via the first RF band of the one or more shared D-SPs on the second RF band, a second mode of the one or more modes being contention for access of the one or more durations via the first RF band, where transmission of the one or more indications of the medium time interval is in association with reception of the indication of the capability.

In some examples, to support communicating with the second wireless communication device, the second RF band communication manager 930 is configurable or configured to communicate with the second wireless communication device and a third wireless communication device over a first shared D-SP of the one or more shared D-SPs via FDM, TDM, or SDM, where the third wireless communication device is one of the first set of two or more second wireless communication devices.

In some examples, the pending buffered data arrived after the one or more shared D-SPs, the one or more durations, or one or more individual D-SPs of the medium time interval.

In some examples, each of the one or more durations is positioned within the medium time interval between the one or more shared D-SPs, the one or more O-SPs, or one or more individual D-SPs.

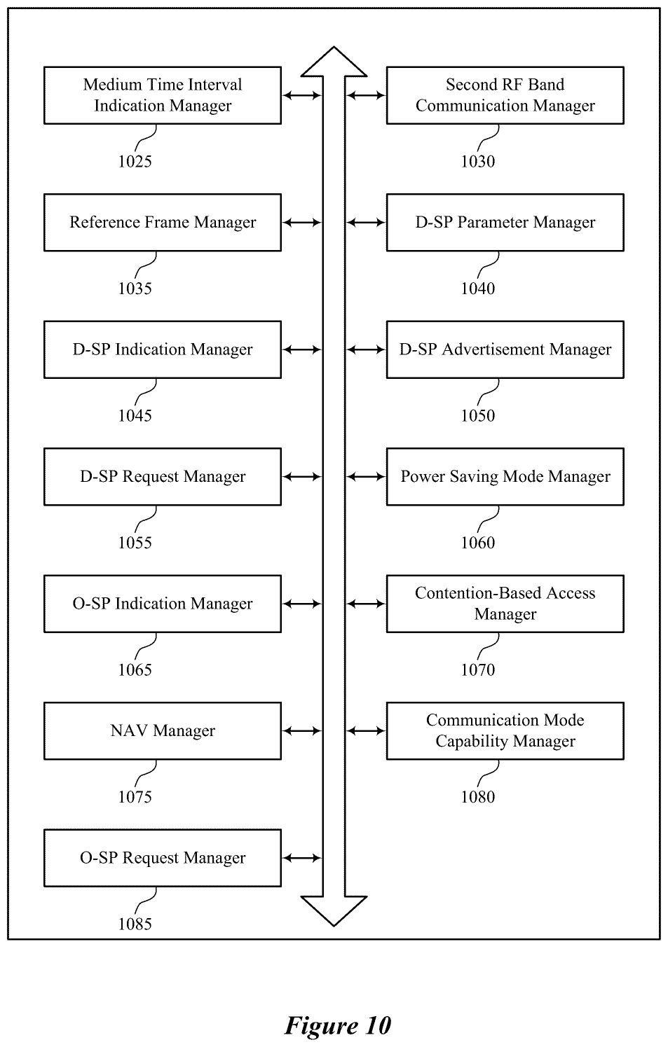

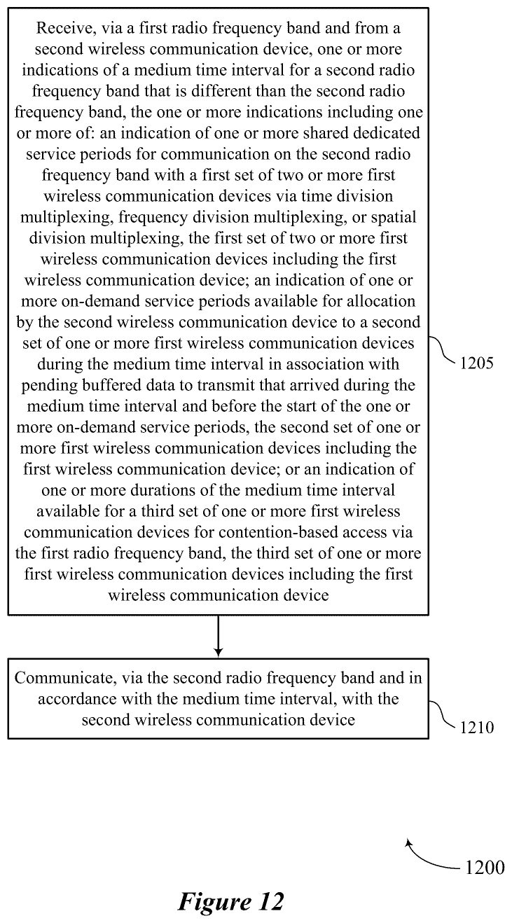

FIG. 10 shows a block diagram of an example first wireless communication device that supports channel access techniques for multi-band operation. In some examples, the first wireless communication device is configured to perform the process 1200 described with reference to FIG. 12. The first wireless communication device may include one or more chips, SoCs, chipsets, packages, components or devices that individually or collectively constitute or include a processing system. The processing system may interface with other components of the first wireless communication device, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the first wireless communication device may transmit the information output from the chip. In such an example, the second interface may refer to an interface between the processing system of the chip and a reception component, such that the first wireless communication device may receive information that is then passed to the processing system. In some such examples, the first interface also may obtain information, such as from the transmission component, and the second interface also may output information, such as to the reception component.

The processing system of the first wireless communication device includes processor (or “processing”) circuitry in the form of one or multiple processors, microprocessors, processing units (such as CPUs, GPUs, NPUs (also referred to as neural network processors or DLPs), or DSPs), processing blocks, ASIC, PLDs (such as FPGAs), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as RAM or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the first wireless communication device can be configurable or configured for use in a STA, such as the STA 104 described with reference to FIG. 1. In some other examples, the first wireless communication device can be a STA that includes such a processing system and other components including multiple antennas. The first wireless communication device is capable of transmitting and receiving wireless communications in the form of, for example, wireless packets. For example, the first wireless communication device can be configurable or configured to transmit and receive packets in the form of physical layer PPDUs and MPDUs conforming to one or more of the IEEE 802.11 family of wireless communication protocol standards. In some other examples, the first wireless communication device can be configurable or configured to transmit and receive signals and communications conforming to one or more 3GPP specifications including those for 5G NR or 6G. In some examples, the first wireless communication device also includes or can be coupled with one or more application processors which may be further coupled with one or more other memories. In some examples, the first wireless communication device further includes a user interface (UI) (such as a touchscreen or keypad) and a display, which may be integrated with the UI to form a touchscreen display that is coupled with the processing system. In some examples, the first wireless communication device may further include one or more sensors such as, for example, one or more inertial sensors, accelerometers, temperature sensors, pressure sensors, or altitude sensors, that are coupled with the processing system.

The first wireless communication device includes a medium time interval indication manager 1025, a second RF band communication manager 1030, a reference frame manager 1035, a D-SP parameter manager 1040, a D-SP indication manager 1045, a D-SP advertisement manager 1050, a D-SP request manager 1055, a power saving mode manager 1060, an O-SP indication manager 1065, a contention-based access manager 1070, a NAV manager 1075, a communication mode capability manager 1080, and an O-SP request manager 1085. Portions of one or more of the medium time interval indication manager 1025, the second RF band communication manager 1030, the reference frame manager 1035, the D-SP parameter manager 1040, the D-SP indication manager 1045, the D-SP advertisement manager 1050, the D-SP request manager 1055, the power saving mode manager 1060, the O-SP indication manager 1065, the contention-based access manager 1070, the NAV manager 1075, the communication mode capability manager 1080, and the O-SP request manager 1085 may be implemented at least in part in hardware or firmware. For example, one or more of the medium time interval indication manager 1025, the second RF band communication manager 1030, the reference frame manager 1035, the D-SP parameter manager 1040, the D-SP indication manager 1045, the D-SP advertisement manager 1050, the D-SP request manager 1055, the power saving mode manager 1060, the O-SP indication manager 1065, the contention-based access manager 1070, the NAV manager 1075, the communication mode capability manager 1080, and the O-SP request manager 1085 may be implemented at least in part by at least a processor or a modem. In some examples, portions of one or more of the medium time interval indication manager 1025, the second RF band communication manager 1030, the reference frame manager 1035, the D-SP parameter manager 1040, the D-SP indication manager 1045, the D-SP advertisement manager 1050, the D-SP request manager 1055, the power saving mode manager 1060, the O-SP indication manager 1065, the contention-based access manager 1070, the NAV manager 1075, the communication mode capability manager 1080, and the O-SP request manager 1085 may be implemented at least in part by a processor and software in the form of processor-executable code stored in memory.

The first wireless communication device may support wireless communications in accordance with examples as disclosed herein. The medium time interval indication manager 1025 is configurable or configured to receive, via a first RF band and from a second wireless communication device, one or more indications of a medium time interval for a second RF band that is different than the second RF band, the one or more indications including one or more of: an indication of one or more shared D-SPs for communication on the second RF band with a first set of two or more first wireless communication devices via TDM, FDM, or SDM, the first set of two or more first wireless communication devices including the first wireless communication device; an indication of one or more O-SPs available for allocation by the second wireless communication device to a second set of one or more first wireless communication devices during the medium time interval in association with pending buffered data to transmit that arrived during the medium time interval and before a start of the one or more O-SPs, the second set of one or more first wireless communication devices including the first wireless communication device; or an indication of one or more durations of the medium time interval available for a third set of one or more first wireless communication devices for contention-based access via the first RF band, the third set of one or more first wireless communication devices including the first wireless communication device. The second RF band communication manager 1030 is configurable or configured to communicate, via the second RF band and in accordance with the medium time interval, with the second wireless communication device.

In some examples, the reference frame manager 1035 is configurable or configured to receive, from the second wireless communication device over a temporally first portion of the medium time interval and via the second RF band, a reference frame for the medium time interval, where the one or more indications of the medium time interval further include an indication of a timing of the reference frame for the medium time interval.

In some examples, the medium time interval indication manager 1025 is configurable or configured to receive, from the second wireless communication device and via the first RF band, one or more second indications of a second medium time interval for the second RF band, the one or more second indications including an indication that the second medium time interval omits a reference frame for the second medium time interval at a second temporally first portion of the second medium time interval.

In some examples, the one or more second indications of the second medium time interval include an indication that the second medium time interval includes, over the second temporally first portion of the second medium time interval: a D-SP for communication on the second RF band with a fourth set of one or more first wireless communication devices, the fourth set of one or more first wireless communication devices including the first wireless communication device; or a second duration for the second RF band available for a fifth set of one or more first wireless communication devices for contention-based access via the first RF band, the fifth set of one or more first wireless communication devices including the first wireless communication device.

In some examples, to support receiving the one or more indications of the medium time interval, the D-SP parameter manager 1040 is configurable or configured to receive an indication of one or more parameters associated with the one or more shared D-SPs, the one or more parameters including an SP duration, a periodicity, supported frame types, a signaling type for SP termination, a signaling type for SP expansion, a signaling type for SP suspension, a signaling type for SP resumption after suspension, an estimated load, an allocation of users, or a combination thereof.

In some examples, to support receiving one or more indications of the medium time interval, the D-SP indication manager 1045 is configurable or configured to receive an indication of an individual D-SP for communication on the second RF band only between the first wireless communication device and the second wireless communication device.

In some examples, the D-SP advertisement manager 1050 is configurable or configured to receive, from the second wireless communication device and via the first RF band, a frame advertising an availability of a set of D-SPs within the medium time interval, the set of D-SPs including the one or more shared D-SPs. In some examples, the D-SP request manager 1055 is configurable or configured to transmit, to the second wireless communication device via the first RF band and responsive to the frame, a request to use the one or more shared D-SPs, where reception of the one or more indications of the medium time interval is in association with transmission of the request.

In some examples, the D-SP request manager 1055 is configurable or configured to transmit, to the second wireless communication device and via the first RF band, a request for establishing the one or more shared D-SPs on the second RF band, where reception of the one or more indications of the medium time interval is in association with transmission of the request.

In some examples, to support communicating with the second wireless communication device, the D-SP indication manager 1045 is configurable or configured to receive, from the second wireless communication device and via the second RF band, a frame including an indication that the second wireless communication device intends to service the first wireless communication device over a first shared D-SP of the one or more shared D-SPs. In some examples, to support communicating with the second wireless communication device, the second RF band communication manager 1030 is configurable or configured to communicate data with the second wireless communication device over the first shared D-SP via the second RF band in association with reception of the frame.

In some examples, to support receiving the frame, the D-SP indication manager 1045 is configurable or configured to receive the frame within a threshold time period of a temporal beginning of the first shared D-SP, where transmission of the frame within the threshold time period includes the indication that the second wireless communication device intends to service the first wireless communication device over the first shared D-SP.

In some examples, the D-SP indication manager 1045 is configurable or configured to receive, from the second wireless communication device and via the first RF band, a frame including an indication that the second wireless communication device does not intend to service the first wireless communication device over a first shared D-SP of the one or more shared D-SPs. In some examples, the power saving mode manager 1060 is configurable or configured to operate, in association with reception of the frame, in a power saving mode over the first shared D-SP.

In some examples, to support receiving the one or more indications of the medium time interval, the O-SP indication manager 1065 is configurable or configured to receive the indication of the one or more O-SPs, where communicating with the second wireless communication device includes communicating with the second wireless communication device over a first O-SP of the one or more O-SPs.

In some examples, the O-SP request manager 1085 is configurable or configured to transmit, to the second wireless communication device, a request to use the first O-SP, where communication with the second wireless communication device over the first O-SP is in association with transmission of the request.

In some examples, the contention-based access manager 1070 is configurable or configured to communicate, with the second wireless communication device and via the first RF band, a request to use a first duration of the one or more durations on the second RF band for communication with the second wireless communication device. In some examples, the contention-based access manager 1070 is configurable or configured to communicate, with the second wireless communication device via the first RF band and in association with communication of the request, a response that indicates an intention to use the second RF band for the first duration for communication with the second wireless communication device.

In some examples, to support communicating the response, the contention-based access manager 1070 is configurable or configured to communicate an indication of an intention to use both the first RF band and the second RF band for the first duration for the communication with the second wireless communication device.

In some examples, the contention-based access manager 1070 is configurable or configured to communicate, with the second wireless communication device and via the first RF band, a request to use a first duration of the one or more durations on the second RF band for communication with the second wireless communication device. In some examples, the contention-based access manager 1070 is configurable or configured to communicate, with the second wireless communication device via the first RF band and in association with communication of the request, a response that indicates an intention to use the first RF band for the first duration for communication with the second wireless communication device.

In some examples, to support communicating with the second wireless communication device, the NAV manager 1075 is configurable or configured to set a network allocation vector to a fixed value for communication via the second RF band with the second wireless communication device.

In some examples, the communication mode capability manager 1080 is configurable or configured to transmit, to the second wireless communication device and via the first RF band, an indication of a capability of the first wireless communication device to support one or more modes of channel access on the second RF band via the first RF band, a first mode of the one or more modes being indication via the first RF band of the one or more shared D-SPs on the second RF band, a second mode of the one or more modes being contention for access of the one or more durations via the first RF band, where transmission of the one or more indications of the medium time interval is in association with transmission of the indication of the capability.

In some examples, to support communicating with the second wireless communication device, the second RF band communication manager 1030 is configurable or configured to communicate with the second wireless communication device over a first shared D-SP of the one or more shared D-SPs via FDM, TDM, or SDM.

In some examples, each of the one or more durations is positioned within the medium time interval between the one or more shared D-SPs, the one or more O-SPs, or one or more individual D-SPs.

FIG. 11 shows a flowchart illustrating an example process 1100 performable by or at a first wireless communication device that supports channel access techniques for multi-band operation. The operations of the process 1100 may be implemented by a first wireless communication device or its components. For example, the process 1100 may be performed by a wireless communication device, such as the first wireless communication device described with reference to FIG. 9, operating as or within a wireless AP. In some examples, the process 1100 may be performed by a wireless AP, such as one of the APs 102 described with reference to FIG. 1.

In some examples, in 1105, the first wireless communication device may transmit, via a first RF band, one or more indications of a medium time interval for a second RF band that is different than the first RF band, the one or more indications including one or more of: an indication of one or more shared D-SPs for communication on the second RF band with a first set of two or more second wireless communication devices via TDM, FDM, or SDM; an indication of one or more O-SPs available for allocation by the first wireless communication device to a second set of one or more second wireless communication devices during the medium time interval in association with pending buffered data to transmit that arrived during the medium time interval and before a start of the one or more O-SPs; or an indication of one or more durations of the medium time interval available for a third set of one or more second wireless communication devices for contention-based access via the first RF band. The operations of 1105 may be performed in accordance with examples as disclosed herein. In some implementations, aspects of the operations of 1105 may be performed by a medium time interval indication manager 925 as described with reference to FIG. 9.

In some examples, in 1110, the first wireless communication device may communicate, via the second RF band and in accordance with the medium time interval, with a second wireless communication device of the first set of two or more second wireless communication devices, the second set of one or more second wireless communication devices, or the third set of one or more second wireless communication devices. The operations of 1110 may be performed in accordance with examples as disclosed herein. In some implementations, aspects of the operations of 1110 may be performed by a second RF band communication manager 930 as described with reference to FIG. 9.

FIG. 12 shows a flowchart illustrating an example process 1200 performable by or at a first wireless communication device that supports channel access techniques for multi-band operation. The operations of the process 1200 may be implemented by a first wireless communication device or its components. For example, the process 1200 may be performed by a wireless communication device, such as the first wireless communication device described with reference to FIG. 10, operating as or within a wireless STA. In some examples, the process 1200 may be performed by a wireless STA, such as one of the STAs 104 described with reference to FIG. 1.

In some examples, in 1205, the first wireless communication device may receive, via a first RF band and from a second wireless communication device, one or more indications of a medium time interval for a second RF band that is different than the second RF band, the one or more indications including one or more of: an indication of one or more shared D-SPs for communication on the second RF band with a first set of two or more first wireless communication devices via TDM, FDM, or SDM, the first set of two or more first wireless communication devices including the first wireless communication device; an indication of one or more O-SPs available for allocation by the second wireless communication device to a second set of one or more first wireless communication devices during the medium time interval in association with pending buffered data to transmit that arrived during the medium time interval and before a start of the one or more O-SPs, the second set of one or more first wireless communication devices including the first wireless communication device; or an indication of one or more durations of the medium time interval available for a third set of one or more first wireless communication devices for contention-based access via the first RF band, the third set of one or more first wireless communication devices including the first wireless communication device. The operations of 1205 may be performed in accordance with examples as disclosed herein. In some implementations, aspects of the operations of 1205 may be performed by a medium time interval indication manager 1025 as described with reference to FIG. 10.

In some examples, in 1210, the first wireless communication device may communicate, via the second RF band and in accordance with the medium time interval, with the second wireless communication device. The operations of 1210 may be performed in accordance with examples as disclosed herein. In some implementations, aspects of the operations of 1210 may be performed by a second RF band communication manager 1030 as described with reference to FIG. 10.

Implementation examples are described in the following numbered clauses:
Aspect 1: A method for wireless communication performed by a first wireless communication device, comprising: transmitting, via a first RF band, one or more indications of a medium time interval for a second RF band that is different than the first RF band, the one or more indications comprising one or more of: an indication of one or more shared D-SPs for communication on the second RF band with a first set of two or more second wireless communication devices via TDM, FDM, or SDM; an indication of one or more O-SPs available for allocation by the first wireless communication device to a second set of one or more second wireless communication devices during the medium time interval in association with pending buffered data to transmit that arrived during the medium time interval and before a start of the one or more O-SPs; or an indication of one or more durations of the medium time interval available for a third set of one or more second wireless communication devices for contention-based access via the first RF band; and communicating, via the second RF band and in accordance with the medium time interval, with a second wireless communication device of the first set of two or more second wireless communication devices, the second set of one or more second wireless communication devices, or the third set of one or more second wireless communication devices.
Aspect 2: The method of aspect 1, further comprising: transmitting, over a temporally-first portion of the medium time interval and via the second RF band, a reference frame for the medium time interval, wherein the one or more indications of the medium time interval further comprise an indication of a timing of the reference frame for the medium time interval.
Aspect 3: The method of aspect 2, further comprising: transmitting, via the first RF band, one or more second indications of a second medium time interval for the second RF band, the one or more second indications comprising an indication that the second medium time interval omits a reference frame for the second medium time interval at a second temporally first portion of the second medium time interval.
Aspect 4: The method of aspect 3, wherein the one or more second indications of the second medium time interval comprise an indication that the second medium time interval includes, over the second temporally first portion of the second medium time interval: a D-SP for communication on the second RF band with a fourth set of one or more second wireless communication devices; or a second duration for the second RF band be available for a fifth set of one or more second wireless communication devices for contention-based access via the first RF band.
Aspect 5: The method of any of aspects 1 through 4, wherein transmitting the one or more indications of the medium time interval comprises: transmitting an indication of one or more parameters associated with the one or more shared D-SPs, the one or more parameters comprising a service period duration, a periodicity, supported frame types, a signaling type for service period termination, a signaling type for service period expansion, a signaling type for service period suspension, a signaling type for service period resumption after suspension, an estimated load, an allocation of users, or a combination thereof.
Aspect 6: The method of any of aspects 1 through 5, wherein transmitting the one or more indications of the medium time interval comprises: transmitting an indication of an individual D-SP for communication with only the first wireless communication device and the second wireless communication device.
Aspect 7: The method of any of aspects 1 through 6, further comprising: transmitting, via the first RF band, a frame advertising an availability of a set of D-SPs within the medium time interval, the set of D-SPs comprising the one or more shared D-SPs; and receiving, via the first RF band from the second wireless communication device and responsive to the frame, a request to use the one or more shared D-SPs, wherein transmission of the one or more indications of the medium time interval is in association with reception of the request, and wherein the first set of two or more second wireless communication devices comprises the second wireless communication device.
Aspect 8: The method of any of aspects 1 through 7, further comprising: receiving, via the first RF band from the second wireless communication device, a request for establishing the one or more shared D-SPs on the second RF band, wherein transmission of the one or more indications of the medium time interval is in association with reception of the request.
Aspect 9: The method of any of aspects 1 through 8, wherein communicating with the second wireless communication device comprises: transmitting, to the second wireless communication device and via the second RF band, a frame comprising an indication that the first wireless communication device intends to service the second wireless communication device over a first shared D-SP of the one or more shared D-SPs; and communicating data with the second wireless communication device over the first shared D-SP via the second RF band in association with transmission of the frame.
Aspect 10: The method of aspect 9, further comprising: transmitting, to a third wireless communication device and via the first RF band, a second frame comprising an indication that the first wireless communication device does not intend to service the third wireless communication device over the first shared D-SP.
Aspect 11: The method of any of aspects 9 through 10, wherein transmitting the frame comprises: transmitting the frame within a threshold time period of a temporal beginning of the first shared D-SP, wherein transmission of the frame within the threshold time period comprises the indication that the first wireless communication device intends to service the second wireless communication device over the first shared D-SP.
Aspect 12: The method of any of aspects 1 through 11, wherein transmitting the one or more indications of the medium time interval comprises: transmitting the indication of the one or more O-SPs, wherein communicating with the second wireless communication device comprises communicating with the second wireless communication device over a first O-SP of the one or more O-SPs.
Aspect 13: The method of aspect 12, further comprising receiving, from the second wireless communication device, a request to use the first O-SP, wherein communication with the second wireless communication device over the first O-SP is in association with reception of the request.
Aspect 14: The method of any of aspects 1 through 13, further comprising: communicating, with the second wireless communication device and via the first RF band, a request to use a first duration of the one or more durations on the second RF band for communication with the second wireless communication device; and communicating, with the second wireless communication device via the first RF band and in association with communication of the request, a response that indicates an intention to use the second RF band for the first duration for communication with the second wireless communication device.
Aspect 15: The method of aspect 14, wherein communicating the response comprises: communicating an indication of an intention to use both the first RF band and the second RF band for the first duration for the communication with the second wireless communication device.
Aspect 16: The method of any of aspects 14 through 15, further comprising: communicating, with a third wireless communication device and via the first RF band, a second request to use the first duration for communication with the third wireless communication device; and transmitting, to the third wireless communication device via the first RF band and in association with communication of the second request, a second response that indicates that the first wireless communication device does not intend to use the second RF band for the first duration for communication with the third wireless communication device in association with transmission of the response, the third wireless communication device being one of the third set of one or more second wireless communication devices.
Aspect 17: The method of any of aspects 1 through 16, wherein communicating with the second wireless communication device comprises: setting a network allocation vector to a fixed value for communication via the second RF band with the second wireless communication device.
Aspect 18: The method of any of aspects 1 through 17, further comprising: receiving, from the second wireless communication device and via the first RF band, an indication of a capability of the second wireless communication device to support one or more modes of channel access on the second RF band via the first RF band, a first mode of the one or more modes being indication via the first RF band of the one or more shared D-SPs on the second RF band, a second mode of the one or more modes being contention for access of the one or more durations via the first RF band, wherein transmission of the one or more indications of the medium time interval is in association with reception of the indication of the capability.
Aspect 19: The method of any of aspects 1 through 18, wherein the pending buffered data arrived after the one or more shared D-SPs, the one or more durations, or one or more individual D-SPs of the medium time interval.
Aspect 20: The method of any of aspects 1 through 19, wherein each of the one or more durations is positioned within the medium time interval between the one or more shared D-SPs, the one or more O-SPs, or one or more individual D-SPs.
Aspect 21: A method for wireless communications at a first wireless communication device, comprising: receiving, via a first RF band and from a second wireless communication device, one or more indications of a medium time interval for a second RF band that is different than the second RF band, the one or more indications comprising one or more of: an indication of one or more shared D-SPs for communication on the second RF band with a first set of two or more first wireless communication devices via TDM, FDM, or SDM, the first set of two or more first wireless communication devices comprising the first wireless communication device; an indication of one or more O-SPs available for allocation by the second wireless communication device to a second set of one or more first wireless communication devices during the medium time interval in association with pending buffered data to transmit that arrived during the medium time interval and before a start of the one or more O-SPs, the second set of one or more first wireless communication devices comprising the first wireless communication device; or an indication of one or more durations of the medium time interval available for a third set of one or more first wireless communication devices for contention-based access via the first RF band, the third set of one or more first wireless communication devices comprising the first wireless communication device; and communicating, via the second RF band and in accordance with the medium time interval, with the second wireless communication device.
Aspect 22: The method of aspect 21, further comprising: receiving, from the second wireless communication device over a temporally first portion of the medium time interval and via the second RF band, a reference frame for the medium time interval, wherein the one or more indications of the medium time interval further comprise an indication of a timing of the reference frame for the medium time interval.
Aspect 23: The method of aspect 22, further comprising: receiving, from the second wireless communication device and via the first RF band, one or more second indications of a second medium time interval for the second RF band, the one or more second indications comprising an indication that the second medium time interval omits a reference frame for the second medium time interval at a second temporally first portion of the second medium time interval.
Aspect 24: The method of aspect 23, wherein the one or more second indications of the second medium time interval comprise an indication that the second medium time interval includes, over the second temporally first portion of the second medium time interval: a D-SP for communication on the second RF band with a fourth set of one or more first wireless communication devices, the fourth set of one or more first wireless communication devices comprising the first wireless communication device; or a second duration for the second RF band be available for a fifth set of one or more first wireless communication devices for contention-based access via the first RF band, the fifth set of one or more first wireless communication devices comprising the first wireless communication device.
Aspect 25: The method of any of aspects 21 through 24, wherein receiving the one or more indications of the medium time interval comprises: receiving an indication of one or more parameters associated with the one or more shared D-SPs, the one or more parameters comprising a service period duration, a periodicity, supported frame types, a signaling type for service period termination, a signaling type for service period expansion, a signaling type for service period suspension, a signaling type for service period resumption after suspension, an estimated load, an allocation of users, or a combination thereof.
Aspect 26: The method of any of aspects 21 through 25, wherein receiving one or more indications of the medium time interval comprises: receiving an indication of an individual D-SP for communication on the second RF band only between the first wireless communication device and the second wireless communication device.
Aspect 27: The method of any of aspects 21 through 26, further comprising: receiving, from the second wireless communication device and via the first RF band, a frame advertising an availability of a set of D-SPs within the medium time interval, the set of D-SPs comprising the one or more shared D-SPs; and transmitting, to the second wireless communication device via the first RF band and responsive to the frame, a request to use the one or more shared D-SPs, wherein reception of the one or more indications of the medium time interval is in association with transmission of the request.
Aspect 28: The method of any of aspects 21 through 27, further comprising: transmitting, to the second wireless communication device and via the first RF band, a request for establishing the one or more shared D-SPs on the second RF band, wherein reception of the one or more indications of the medium time interval is in association with transmission of the request.
Aspect 29: The method of any of aspects 21 through 28, wherein communicating with the second wireless communication device comprises: receiving, from the second wireless communication device and via the second RF band, a frame comprising an indication that the second wireless communication device intends to service the first wireless communication device over a first shared D-SP of the one or more shared D-SPs; and communicating data with the second wireless communication device over the first shared D-SP via the second RF band in association with reception of the frame.
Aspect 30: The method of aspect 29, wherein receiving the frame comprises: receiving the frame within a threshold time period of a temporal beginning of the first shared D-SP, wherein transmission of the frame within the threshold time period comprises the indication that the second wireless communication device intends to service the first wireless communication device over the first shared D-SP.
Aspect 31: The method of any of aspects 21 through 28, further comprising: receiving, from the second wireless communication device and via the first RF band, a frame comprising an indication that the second wireless communication device does not intend to service the first wireless communication device over a first shared D-SP of the one or more shared D-SPs; and operating, in association with reception of the frame, in a power saving mode over the first shared D-SP.
Aspect 32: The method of any of aspects 21 through 31, wherein receiving the one or more indications of the medium time interval comprises: receiving the indication of the one or more O-SPs, wherein communicating with the second wireless communication device comprises communicating with the second wireless communication device over a first O-SP of the one or more O-SPs.
Aspect 33: The method of aspect 32, further comprising transmitting, to the second wireless communication device, a request to use the first O-SP, wherein communication with the second wireless communication device over the first O-SP is in association with transmission of the request.
Aspect 34: The method of any of aspects 21 through 33, further comprising: communicating, with the second wireless communication device and via the first RF band, a request to use a first duration of the one or more durations on the second RF band for communication with the second wireless communication device; and communicating, with the second wireless communication device via the first RF band and in association with communication of the request, a response that indicates an intention to use the second RF band for the first duration for communication with the second wireless communication device.
Aspect 35: The method of aspect 34, wherein communicating the response comprises: communicating an indication of an intention to use both the first RF band and the second RF band for the first duration for the communication with the second wireless communication device.
Aspect 36: The method of any of aspects 21 through 35, wherein communicating with the second wireless communication device comprises: setting a network allocation vector to a fixed value for communication via the second RF band with the second wireless communication device.
Aspect 37: The method of any of aspects 21 through 36, further comprising: transmitting, to the second wireless communication device and via the first RF band, an indication of a capability of the first wireless communication device to support one or more modes of channel access on the second RF band via the first RF band, a first mode of the one or more modes being indication via the first RF band of the one or more shared D-SPs on the second RF band, a second mode of the one or more modes being contention for access of the one or more durations via the first RF band, wherein transmission of the one or more indications of the medium time interval is in association with transmission of the indication of the capability.
Aspect 38: The method of any of aspects 21 through 37, wherein communicating with the second wireless communication device comprises: communicating with the second wireless communication device over a first shared D-SP of the one or more shared D-SPs via frequency division multiplexing, time division multiplexing, or spatial division multiplexing.
Aspect 39: The method of any of aspects 21 through 38, wherein each of the one or more durations is positioned within the medium time interval between the one or more shared D-SPs, the one or more O-SPs, or one or more individual D-SPs.
Aspect 40: A first wireless communication device, comprising: a processing system that includes processor circuitry and memory circuitry that stores code, the processing system configured to cause the first wireless communication device to perform a method of any of aspects 1 through 20.
Aspect 41: A first wireless communication device for wireless communication, comprising at least one means for performing a method of any of aspects 1 through 20.
Aspect 42: A non-transitory computer-readable medium storing code for wireless communication, the code comprising instructions executable by one or more processors to perform a method of any of aspects 1 through 20.
Aspect 43: A first wireless communication device, comprising: a processing system that includes processor circuitry and memory circuitry that stores code, the processing system configured to cause the first wireless communication device to perform a method of any of aspects 21 through 39.
Aspect 44: A first wireless communication device for wireless communications, comprising at least one means for performing a method of any of aspects 21 through 39.
Aspect 45: A non-transitory computer-readable medium storing code for wireless communications, the code comprising instructions executable by one or more processors to perform a method of any of aspects 21 through 39.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only “a,” or the equivalent in context, whatever it is that is “based on”a,” or “based at least in part on “a,” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can In some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless communication device, comprising:
a processing system that includes processor circuitry and memory circuitry that stores code, the processing system configured to cause the first wireless communication device to:
transmit, via a first radio frequency band, one or more indications of a medium time interval for a second radio frequency band that is different than the first radio frequency band, the one or more indications comprising one or more of:
an indication of one or more shared dedicated service periods for communication on the second radio frequency band with a first set of two or more second wireless communication devices via time division multiplexing, frequency division multiplexing, or spatial division multiplexing;
an indication of one or more on-demand service periods available for allocation by the first wireless communication device to a second set of one or more second wireless communication devices during the medium time interval in association with pending buffered data to transmit that arrived during the medium time interval and before a start of the one or more on-demand service periods; or
an indication of one or more durations of the medium time interval available for a third set of one or more second wireless communication devices for contention-based access via the first radio frequency band; and
communicate, via the second radio frequency band and in accordance with the medium time interval, with a second wireless communication device of the first set of two or more second wireless communication devices, the second set of one or more second wireless communication devices, or the third set of one or more second wireless communication devices.

2. The first wireless communication device of claim 1, wherein the processing system is further configured to cause the first wireless communication device to transmit, over a temporally-first portion of the medium time interval and via the second radio frequency band, a reference frame for the medium time interval, wherein the one or more indications of the medium time interval further comprise an indication of a timing of the reference frame for the medium time interval.

3. The first wireless communication device of claim 2, wherein the processing system is further configured to cause the first wireless communication device to transmit, via the first radio frequency band, one or more second indications of a second medium time interval for the second radio frequency band, the one or more second indications comprising an indication that the second medium time interval omits a reference frame for the second medium time interval at a second temporally first portion of the second medium time interval.

4. The first wireless communication device of claim 3, wherein the one or more second indications of the second medium time interval comprise an indication that the second medium time interval includes, over the second temporally first portion of the second medium time interval:
a dedicated service period for communication on the second radio frequency band with a fourth set of one or more second wireless communication devices; or
a second duration for the second radio frequency band available for a fifth set of one or more second wireless communication devices for contention-based access via the first radio frequency band.

5. The first wireless communication device of claim 1, wherein, to transmit the one or more indications of the medium time interval, the processing system is configured to cause the first wireless communication device to transmit an indication of one or more parameters associated with the one or more shared dedicated service periods, the one or more parameters comprising a service period duration, a periodicity, supported frame types, a signaling type for service period termination, a signaling type for service period expansion, a signaling type for service period suspension, a signaling type for service period resumption after suspension, an estimated load, an allocation of users, or a combination thereof.

6. The first wireless communication device of claim 1, wherein, to transmit the one or more indications of the medium time interval, the processing system is configured to cause the first wireless communication device to transmit an indication of an individual dedicated service period for communication with only the first wireless communication device and the second wireless communication device.

7. The first wireless communication device of claim 1, wherein the processing system is further configured to cause the first wireless communication device to:
transmit, via the first radio frequency band, a frame advertising an availability of a set of dedicated service periods within the medium time interval, the set of dedicated service periods comprising the one or more shared dedicated service periods; and
receive, via the first radio frequency band from the second wireless communication device and responsive to the frame, a request to use the one or more shared dedicated service periods, wherein transmission of the one or more indications of the medium time interval is in association with reception of the request, and wherein the first set of two or more second wireless communication devices comprises the second wireless communication device.

8. The first wireless communication device of claim 1, wherein the processing system is further configured to cause the first wireless communication device to receive, via the first radio frequency band from the second wireless communication device, a request for establishing the one or more shared dedicated service periods on the second radio frequency band, wherein transmission of the one or more indications of the medium time interval is in association with reception of the request.

9. The first wireless communication device of claim 1, wherein, to communicate with the second wireless communication device, the processing system is configured to cause the first wireless communication device to:
transmit, to the second wireless communication device and via the second radio frequency band, a frame comprising an indication that the first wireless communication device intends to service the second wireless communication device over a first shared dedicated service period of the one or more shared dedicated service periods; and
communicate data with the second wireless communication device over the first shared dedicated service period via the second radio frequency band in association with transmission of the frame.

10. The first wireless communication device of claim 9, wherein the processing system is further configured to cause the first wireless communication device to transmit, to a third wireless communication device and via the first radio frequency band, a second frame comprising an indication that the first wireless communication device does not intend to service the third wireless communication device over the first shared dedicated service period.

11. The first wireless communication device of claim 9, wherein, to transmit the frame, the processing system is configured to cause the first wireless communication device to transmit the frame within a threshold time period of a temporal beginning of the first shared dedicated service period, wherein transmission of the frame within the threshold time period comprises the indication that the first wireless communication device intends to service the second wireless communication device over the first shared dedicated service period.

12. The first wireless communication device of claim 1, wherein, to transmit the one or more indications of the medium time interval, the processing system is configured to cause the first wireless communication device to transmit the indication of the one or more on-demand service periods, wherein communicating with the second wireless communication device comprises communicating with the second wireless communication device over a first on-demand service period of the one or more on-demand service periods.

13. The first wireless communication device of claim 12, wherein the processing system is further configured to cause the first wireless communication device to receive, from the second wireless communication device, a request to use the first on-demand service period, wherein communication with the second wireless communication device over the first on-demand service period is in association with reception of the request.

14. The first wireless communication device of claim 1, wherein the processing system is further configured to cause the first wireless communication device to:
communicate, with the second wireless communication device and via the first radio frequency band, a request to use a first duration of the one or more durations on the second radio frequency band for communication with the second wireless communication device; and
communicate, with the second wireless communication device via the first radio frequency band and in association with communication of the request, a response that indicates an intention to use the second radio frequency band for the first duration for communication with the second wireless communication device.

15. The first wireless communication device of claim 14, wherein, to communicate the response, the processing system is configured to cause the first wireless communication device to communicate an indication of an intention to use both the first radio frequency band and the second radio frequency band for the first duration for the communication with the second wireless communication device.

16. The first wireless communication device of claim 14, wherein the processing system is further configured to cause the first wireless communication device to:
communicate, with a third wireless communication device and via the first radio frequency band, a second request to use the first duration for communication with the third wireless communication device; and
transmit, to the third wireless communication device via the first radio frequency band and in association with communication of the second request, a second response that indicates that the first wireless communication device does not intend to use the second radio frequency band for the first duration for communication with the third wireless communication device in association with transmission of the response, the third wireless communication device being one of the third set of one or more second wireless communication devices.

17. The first wireless communication device of claim 1, wherein, to communicate with the second wireless communication device, the processing system is configured to cause the first wireless communication device to set a network allocation vector to a fixed value for communication via the second radio frequency band with the second wireless communication device.

18. The first wireless communication device of claim 1, wherein the processing system is further configured to cause the first wireless communication device to receive, from the second wireless communication device and via the first radio frequency band, an indication of a capability of the second wireless communication device to support one or more modes of channel access on the second radio frequency band via the first radio frequency band, a first mode of the one or more modes being indication via the first radio frequency band of the one or more shared dedicated service periods on the second radio frequency band, a second mode of the one or more modes being contention for access of the one or more durations via the first radio frequency band, wherein transmission of the one or more indications of the medium time interval is in association with reception of the indication of the capability.

19. The first wireless communication device of claim 1, wherein the pending buffered data arrived after the one or more shared dedicated service periods, the one or more durations, or one or more individual dedicated service periods of the medium time interval.

20. The first wireless communication device of claim 1, wherein each of the one or more durations is positioned within the medium time interval between the one or more shared dedicated service periods, the one or more on-demand service periods, or one or more individual dedicated service periods.

21. A first wireless communication device, comprising:
a processing system that includes processor circuitry and memory circuitry that stores code, the processing system configured to cause the first wireless communication device to:
receive, via a first radio frequency band and from a second wireless communication device, one or more indications of a medium time interval for a second radio frequency band that is different than the second radio frequency band, the one or more indications comprising one or more of:
an indication of one or more shared dedicated service periods for communication on the second radio frequency band with a first set of two or more first wireless communication devices via time division multiplexing, frequency division multiplexing, or spatial division multiplexing, the first set of two or more first wireless communication devices comprising the first wireless communication device;
an indication of one or more on-demand service periods available for allocation by the second wireless communication device to a second set of one or more first wireless communication devices during the medium time interval in association with pending buffered data to transmit that arrived during the medium time interval and before a start of the one or more on-demand service periods, the second set of one or more first wireless communication devices comprising the first wireless communication device; or
an indication of one or more durations of the medium time interval available for a third set of one or more first wireless communication devices for contention-based access via the first radio frequency band, the third set of one or more first wireless communication devices comprising the first wireless communication device; and
communicate, via the second radio frequency band and in accordance with the medium time interval, with the second wireless communication device.

22. The first wireless communication device of claim 21, wherein the processing system is further configured to cause the first wireless communication device to receive, from the second wireless communication device over a temporally first portion of the medium time interval and via the second radio frequency band, a reference frame for the medium time interval, wherein the one or more indications of the medium time interval further comprise an indication of a timing of the reference frame for the medium time interval.

23. The first wireless communication device of claim 22, wherein the processing system is further configured to cause the first wireless communication device to receive, from the second wireless communication device and via the first radio frequency band, one or more second indications of a second medium time interval for the second radio frequency band, the one or more second indications comprising an indication that the second medium time interval omits a reference frame for the second medium time interval at a second temporally first portion of the second medium time interval.

24. The first wireless communication device of claim 23, wherein the one or more second indications of the second medium time interval comprise an indication that the second medium time interval includes, over the second temporally first portion of the second medium time interval:
a dedicated service period for communication on the second radio frequency band with a fourth set of one or more first wireless communication devices, the fourth set of one or more first wireless communication devices comprising the first wireless communication device; or
a second duration for the second radio frequency band available for a fifth set of one or more first wireless communication devices for contention-based access via the first radio frequency band, the fifth set of one or more first wireless communication devices comprising the first wireless communication device.

25. The first wireless communication device of claim 21, wherein, to receive the one or more indications of the medium time interval, the processing system is configured to cause the first wireless communication device to receive an indication of one or more parameters associated with the one or more shared dedicated service periods, the one or more parameters comprising a service period duration, a periodicity, supported frame types, a signaling type for service period termination, a signaling type for service period expansion, a signaling type for service period suspension, a signaling type for service period resumption after suspension, an estimated load, an allocation of users, or a combination thereof.

26. The first wireless communication device of claim 21, wherein, to receive one or more indications of the medium time interval, the processing system is configured to cause the first wireless communication device to receive an indication of an individual dedicated service period for communication on the second radio frequency band only between the first wireless communication device and the second wireless communication device.

27. The first wireless communication device of claim 21, wherein the processing system is further configured to cause the first wireless communication device to:
receive, from the second wireless communication device and via the first radio frequency band, a frame advertising an availability of a set of dedicated service periods within the medium time interval, the set of dedicated service periods comprising the one or more shared dedicated service periods; and
transmit, to the second wireless communication device via the first radio frequency band and responsive to the frame, a request to use the one or more shared dedicated service periods, wherein reception of the one or more indications of the medium time interval is in association with transmission of the request.

28. The first wireless communication device of claim 21, wherein the processing system is further configured to cause the first wireless communication device to transmit, to the second wireless communication device and via the first radio frequency band, a request for establishing the one or more shared dedicated service periods on the second radio frequency band, wherein reception of the one or more indications of the medium time interval is in association with transmission of the request.

29. The first wireless communication device of claim 21, wherein, to communicate with the second wireless communication device, the processing system is configured to cause the first wireless communication device to:
receive, from the second wireless communication device and via the second radio frequency band, a frame comprising an indication that the second wireless communication device intends to service the first wireless communication device over a first shared dedicated service period of the one or more shared dedicated service periods; and
communicate data with the second wireless communication device over the first shared dedicated service period via the second radio frequency band in association with reception of the frame.

30. The first wireless communication device of claim 29, wherein, to receive the frame, the processing system is configured to cause the first wireless communication device to receive the frame within a threshold time period of a temporal beginning of the first shared dedicated service period, wherein transmission of the frame within the threshold time period comprises the indication that the second wireless communication device intends to service the first wireless communication device over the first shared dedicated service period.

31. The first wireless communication device of claim 21, wherein the processing system is further configured to cause the first wireless communication device to:
receive, from the second wireless communication device and via the first radio frequency band, a frame comprising an indication that the second wireless communication device does not intend to service the first wireless communication device over a first shared dedicated service period of the one or more shared dedicated service periods; and
operate, in association with reception of the frame, in a power saving mode over the first shared dedicated service period.

32. The first wireless communication device of claim 21, wherein, to receive the one or more indications of the medium time interval, the processing system is configured to cause the first wireless communication device to receive the indication of the one or more on-demand service periods, wherein communicating with the second wireless communication device comprises communicating with the second wireless communication device over a first on-demand service period of the one or more on-demand service periods.

33. The first wireless communication device of claim 32, wherein the processing system is further configured to cause the first wireless communication device to transmit, to the second wireless communication device, a request to use the first on-demand service period, wherein communication with the second wireless communication device over the first on-demand service period is in association with transmission of the request.

34. The first wireless communication device of claim 21, wherein the processing system is further configured to cause the first wireless communication device to:
communicate, with the second wireless communication device and via the first radio frequency band, a request to use a first duration of the one or more durations on the second radio frequency band for communication with the second wireless communication device; and
communicate, with the second wireless communication device via the first radio frequency band and in association with communication of the request, a response that indicates an intention to use the second radio frequency band for the first duration for communication with the second wireless communication device.

35. The first wireless communication device of claim 34, wherein, to communicate the response, the processing system is configured to cause the first wireless communication device to communicate an indication of an intention to use both the first radio frequency band and the second radio frequency band for the first duration for the communication with the second wireless communication device.

36. The first wireless communication device of claim 21, wherein, to communicate with the second wireless communication device, the processing system is configured to cause the first wireless communication device to set a network allocation vector to a fixed value for communication via the second radio frequency band with the second wireless communication device.

37. The first wireless communication device of claim 21, wherein the processing system is further configured to cause the first wireless communication device to transmit, to the second wireless communication device and via the first radio frequency band, an indication of a capability of the first wireless communication device to support one or more modes of channel access on the second radio frequency band via the first radio frequency band, a first mode of the one or more modes being indication via the first radio frequency band of the one or more shared dedicated service periods on the second radio frequency band, a second mode of the one or more modes being contention for access of the one or more durations via the first radio frequency band, wherein transmission of the one or more indications of the medium time interval is in association with transmission of the indication of the capability.

38. The first wireless communication device of claim 21, wherein, to communicate with the second wireless communication device, the processing system is configured to cause the first wireless communication device to communicate with the second wireless communication device over a first shared dedicated service period of the one or more shared dedicated service periods via frequency division multiplexing, time division multiplexing, or spatial division multiplexing.

39. The first wireless communication device of claim 21, wherein each of the one or more durations is positioned within the medium time interval between the one or more shared dedicated service periods, the one or more on-demand service periods, or one or more individual dedicated service periods.

40. A method for wireless communication performed by a first wireless communication device, comprising:
transmitting, via a first radio frequency band, one or more indications of a medium time interval for a second radio frequency band that is different than the first radio frequency band, the one or more indications comprising one or more of:
an indication of one or more shared dedicated service periods for communication on the second radio frequency band with a first set of two or more second wireless communication devices via time division multiplexing, frequency division multiplexing, or spatial division multiplexing;
an indication of one or more on-demand service periods available for allocation by the first wireless communication device to a second set of one or more second wireless communication devices during the medium time interval in association with pending buffered data to transmit that arrived during the medium time interval and before a start of the one or more on-demand service periods; or
an indication of one or more durations of the medium time interval available for a third set of one or more second wireless communication devices for contention-based access via the first radio frequency band; and
communicating, via the second radio frequency band and in accordance with the medium time interval, with a second wireless communication device of the first set of two or more second wireless communication devices, the second set of one or more second wireless communication devices, or the third set of one or more second wireless communication devices.

41. The method of claim 40, further comprising transmitting, over a temporally-first portion of the medium time interval and via the second radio frequency band, a reference frame for the medium time interval, wherein the one or more indications of the medium time interval further comprise an indication of a timing of the reference frame for the medium time interval.

42. The method of claim 41, further comprising transmitting, via the first radio frequency band, one or more second indications of a second medium time interval for the second radio frequency band, the one or more second indications comprising an indication that the second medium time interval omits a reference frame for the second medium time interval at a second temporally first portion of the second medium time interval.

43. The method of claim 42, wherein the one or more second indications of the second medium time interval comprise an indication that the second medium time interval includes, over the second temporally first portion of the second medium time interval:
a dedicated service period for communication on the second radio frequency band with a fourth set of one or more second wireless communication devices; or
a second duration for the second radio frequency band available for a fifth set of one or more second wireless communication devices for contention-based access via the first radio frequency band.

44. The method of claim 40, wherein transmitting the one or more indications of the medium time interval comprises transmitting an indication of one or more parameters associated with the one or more shared dedicated service periods, the one or more parameters comprising a service period duration, a periodicity, supported frame types, a signaling type for service period termination, a signaling type for service period expansion, a signaling type for service period suspension, a signaling type for service period resumption after suspension, an estimated load, an allocation of users, or a combination thereof.

45. The method of claim 40, wherein transmitting the one or more indications of the medium time interval comprises transmitting an indication of an individual dedicated service period for communication with only the first wireless communication device and the second wireless communication device.

46. The method of claim 40, further comprising:
transmitting, via the first radio frequency band, a frame advertising an availability of a set of dedicated service periods within the medium time interval, the set of dedicated service periods comprising the one or more shared dedicated service periods; and
receiving, via the first radio frequency band from the second wireless communication device and responsive to the frame, a request to use the one or more shared dedicated service periods, wherein transmission of the one or more indications of the medium time interval is in association with reception of the request, and wherein the first set of two or more second wireless communication devices comprises the second wireless communication device.

47. The method of claim 40, further comprising receiving, via the first radio frequency band from the second wireless communication device, a request for establishing the one or more shared dedicated service periods on the second radio frequency band, wherein transmission of the one or more indications of the medium time interval is in association with reception of the request.

48. The method of claim 40, wherein communicating with the second wireless communication device comprises:
transmitting, to the second wireless communication device and via the second radio frequency band, a frame comprising an indication that the first wireless communication device intends to service the second wireless communication device over a first shared dedicated service period of the one or more shared dedicated service periods; and
communicating data with the second wireless communication device over the first shared dedicated service period via the second radio frequency band in association with transmission of the frame.

49. The method of claim 48, further comprising transmitting, to a third wireless communication device and via the first radio frequency band, a second frame comprising an indication that the first wireless communication device does not intend to service the third wireless communication device over the first shared dedicated service period.

50. The method of claim 48, wherein transmitting the frame comprises transmitting the frame within a threshold time period of a temporal beginning of the first shared dedicated service period, wherein transmission of the frame within the threshold time period comprises the indication that the first wireless communication device intends to service the second wireless communication device over the first shared dedicated service period.

51. The method of claim 40, wherein transmitting the one or more indications of the medium time interval comprises transmitting the indication of the one or more on-demand service periods, wherein communicating with the second wireless communication device comprises communicating with the second wireless communication device over a first on-demand service period of the one or more on-demand service periods.

52. The method of claim 51, further comprising receiving, from the second wireless communication device, a request to use the first on-demand service period, wherein communication with the second wireless communication device over the first on-demand service period is in association with reception of the request.

53. The method of claim 40, further comprising:
communicating, with the second wireless communication device and via the first radio frequency band, a request to use a first duration of the one or more durations on the second radio frequency band for communication with the second wireless communication device; and
communicating, with the second wireless communication device via the first radio frequency band and in association with communication of the request, a response that indicates an intention to use the second radio frequency band for the first duration for communication with the second wireless communication device.

54. The method of claim 53, wherein communicating the response comprises communicating an indication of an intention to use both the first radio frequency band and the second radio frequency band for the first duration for the communication with the second wireless communication device.

55. The method of claim 53, further comprising:
communicating, with a third wireless communication device and via the first radio frequency band, a second request to use the first duration for communication with the third wireless communication device; and
transmitting, to the third wireless communication device via the first radio frequency band and in association with communication of the second request, a second response that indicates that the first wireless communication device does not intend to use the second radio frequency band for the first duration for communication with the third wireless communication device in association with transmission of the response, the third wireless communication device being one of the third set of one or more second wireless communication devices.

56. The method of claim 40, wherein communicating with the second wireless communication device comprises setting a network allocation vector to a fixed value for communication via the second radio frequency band with the second wireless communication device.

57. The method of claim 40, further comprising receiving, from the second wireless communication device and via the first radio frequency band, an indication of a capability of the second wireless communication device to support one or more modes of channel access on the second radio frequency band via the first radio frequency band, a first mode of the one or more modes being indication via the first radio frequency band of the one or more shared dedicated service periods on the second radio frequency band, a second mode of the one or more modes being contention for access of the one or more durations via the first radio frequency band, wherein transmission of the one or more indications of the medium time interval is in association with reception of the indication of the capability.

58. The method of claim 40, wherein the pending buffered data arrived after the one or more shared dedicated service periods, the one or more durations, or one or more individual dedicated service periods of the medium time interval.

59. The method of claim 40, wherein each of the one or more durations is positioned within the medium time interval between the one or more shared dedicated service periods, the one or more on-demand service periods, or one or more individual dedicated service periods.

60. A method for wireless communications at a first wireless communication device, comprising:
receiving, via a first radio frequency band and from a second wireless communication device, one or more indications of a medium time interval for a second radio frequency band that is different than the second radio frequency band, the one or more indications comprising one or more of:
an indication of one or more shared dedicated service periods for communication on the second radio frequency band with a first set of two or more first wireless communication devices via time division multiplexing, frequency division multiplexing, or spatial division multiplexing, the first set of two or more first wireless communication devices comprising the first wireless communication device;
an indication of one or more on-demand service periods available for allocation by the second wireless communication device to a second set of one or more first wireless communication devices during the medium time interval in association with pending buffered data to transmit that arrived during the medium time interval and before a start of the one or more on-demand service periods, the second set of one or more first wireless communication devices comprising the first wireless communication device; or
an indication of one or more durations of the medium time interval available for a third set of one or more first wireless communication devices for contention-based access via the first radio frequency band, the third set of one or more first wireless communication devices comprising the first wireless communication device; and
communicating, via the second radio frequency band and in accordance with the medium time interval, with the second wireless communication device.

61. The method of claim 60, further comprising receiving, from the second wireless communication device over a temporally first portion of the medium time interval and via the second radio frequency band, a reference frame for the medium time interval, wherein the one or more indications of the medium time interval further comprise an indication of a timing of the reference frame for the medium time interval.

62. The method of claim 61, further comprising receiving, from the second wireless communication device and via the first radio frequency band, one or more second indications of a second medium time interval for the second radio frequency band, the one or more second indications comprising an indication that the second medium time interval omits a reference frame for the second medium time interval at a second temporally first portion of the second medium time interval.

63. The method of claim 62, wherein the one or more second indications of the second medium time interval comprise an indication that the second medium time interval includes, over the second temporally first portion of the second medium time interval:
a dedicated service period for communication on the second radio frequency band with a fourth set of one or more first wireless communication devices, the fourth set of one or more first wireless communication devices comprising the first wireless communication device; or
a second duration for the second radio frequency band available for a fifth set of one or more first wireless communication devices for contention-based access via the first radio frequency band, the fifth set of one or more first wireless communication devices comprising the first wireless communication device.

64. The method of claim 60, wherein receiving the one or more indications of the medium time interval comprises receiving an indication of one or more parameters associated with the one or more shared dedicated service periods, the one or more parameters comprising a service period duration, a periodicity, supported frame types, a signaling type for service period termination, a signaling type for service period expansion, a signaling type for service period suspension, a signaling type for service period resumption after suspension, an estimated load, an allocation of users, or a combination thereof.

65. The method of claim 60, wherein receiving one or more indications of the medium time interval comprises receiving an indication of an individual dedicated service period for communication on the second radio frequency band only between the first wireless communication device and the second wireless communication device.

66. The method of claim 60, further comprising:
receiving, from the second wireless communication device and via the first radio frequency band, a frame advertising an availability of a set of dedicated service periods within the medium time interval, the set of dedicated service periods comprising the one or more shared dedicated service periods; and
transmitting, to the second wireless communication device via the first radio frequency band and responsive to the frame, a request to use the one or more shared dedicated service periods, wherein reception of the one or more indications of the medium time interval is in association with transmission of the request.

67. The method of claim 60, further comprising transmitting, to the second wireless communication device and via the first radio frequency band, a request for establishing the one or more shared dedicated service periods on the second radio frequency band, wherein reception of the one or more indications of the medium time interval is in association with transmission of the request.

68. The method of claim 60, wherein communicating with the second wireless communication device comprises:
receiving, from the second wireless communication device and via the second radio frequency band, a frame comprising an indication that the second wireless communication device intends to service the first wireless communication device over a first shared dedicated service period of the one or more shared dedicated service periods; and
communicating data with the second wireless communication device over the first shared dedicated service period via the second radio frequency band in association with reception of the frame.

69. The method of claim 68, wherein receiving the frame comprises receiving the frame within a threshold time period of a temporal beginning of the first shared dedicated service period, wherein transmission of the frame within the threshold time period comprises the indication that the second wireless communication device intends to service the first wireless communication device over the first shared dedicated service period.

70. The method of claim 60, further comprising:
receiving, from the second wireless communication device and via the first radio frequency band, a frame comprising an indication that the second wireless communication device does not intend to service the first wireless communication device over a first shared dedicated service period of the one or more shared dedicated service periods; and
operating, in association with reception of the frame, in a power saving mode over the first shared dedicated service period.

71. The method of claim 60, wherein receiving the one or more indications of the medium time interval comprises receiving the indication of the one or more on-demand service periods, wherein communicating with the second wireless communication device comprises communicating with the second wireless communication device over a first on-demand service period of the one or more on-demand service periods.

72. The method of claim 71, further comprising transmitting, to the second wireless communication device, a request to use the first on-demand service period, wherein communication with the second wireless communication device over the first on-demand service period is in association with transmission of the request.

73. The method of claim 60, further comprising:
communicating, with the second wireless communication device and via the first radio frequency band, a request to use a first duration of the one or more durations on the second radio frequency band for communication with the second wireless communication device; and
communicating, with the second wireless communication device via the first radio frequency band and in association with communication of the request, a response that indicates an intention to use the second radio frequency band for the first duration for communication with the second wireless communication device.

74. The method of claim 73, wherein communicating the response comprises communicating an indication of an intention to use both the first radio frequency band and the second radio frequency band for the first duration for the communication with the second wireless communication device.

75. The method of claim 60, wherein communicating with the second wireless communication device comprises setting a network allocation vector to a fixed value for communication via the second radio frequency band with the second wireless communication device.

76. The method of claim 60, further comprising transmitting, to the second wireless communication device and via the first radio frequency band, an indication of a capability of the first wireless communication device to support one or more modes of channel access on the second radio frequency band via the first radio frequency band, a first mode of the one or more modes being indication via the first radio frequency band of the one or more shared dedicated service periods on the second radio frequency band, a second mode of the one or more modes being contention for access of the one or more durations via the first radio frequency band, wherein transmission of the one or more indications of the medium time interval is in association with transmission of the indication of the capability.

77. The method of claim 60, wherein communicating with the second wireless communication device comprises communicating with the second wireless communication device over a first shared dedicated service period of the one or more shared dedicated service periods via frequency division multiplexing, time division multiplexing, or spatial division multiplexing.

78. The method of claim 60, wherein each of the one or more durations is positioned within the medium time interval between the one or more shared dedicated service periods, the one or more on-demand service periods, or one or more individual dedicated service periods.
